(19) United States
(12) Patent Application Publication
(10) Pub. No.: US 2020/0068609 A1
(43) Pub. Date: Feb. 27, 2020

(54) RESOURCE CONFIGURATION AND SCHEDULING METHOD, BASE STATION, AND USER EQUIPMENT

(71) Applicant: NTT DOCOMO, INC., Tokyo (JP)

(72) Inventors: Huan WANG, Beijing (CN); Qun ZHAO, Beijing (CN); Xiaolin HOU, Beijing (CN)

(73) Assignee: NTT DOCOMO, INC., Tokyo (JP)

(21) Appl. No.: 16/609,566

(22) PCT Filed: Mar. 2, 2018
(86) PCT No.: PCT/CN2018/077827

§ 371 Date: Oct. 30, 2019

(30) Foreign Application Priority Data
May 4, 2017 (CN) 201710309560.9

(51) Int. Cl. H04W 72/12; H04W 72/04

(52) U.S. Cl. CPC H04W 72/1289; H04W 72/0446

(57) ABSTRACT

A resource configuring and scheduling method is presented, a base station, and a user equipment. The method being performed by a base station, includes: configuring a first resource pool, with the first resource pool being used for information transmission of a first type of UE in a sidelink transmission mode, where the first type of UE carries out a sidelink transmission by base station scheduling; configuring a second resource pool, with the second resource pool being used for information transmission of a second type of UE in a sidelink transmission mode, where the second type of UE autonomously carries out the sidelink transmission, and the first resource pool and the second resource pool are orthogonal to each other.

### TECHNICAL FIELD

The present invention relates to field of wireless communications, and in particular to a resource configuration and scheduling method, a base station, and a user equipment that may be used in a wireless communication system.

### BACKGROUND

Device to device communications (D2D communications) has become an important technology used in 4G and 5G communication systems. In addition to the conventional Uu interface for uplink and downlink transmission between the user equipment and the base station, in order to support device to device communications, a PC5 interface is also proposed in the communication system. The PC5 interface may have a plurality of modes depending on different application scenarios. For example, mode 3 for a first type of UE in range, and mode 4 for a second type of UE in range and UE not in range. The first type of UE carries out sidelink transmission by base station scheduling, and the second type of UE carries out the sidelink transmission autonomously.

The base station may respectively configure, for mode 3 and mode 4 of the PC5 interface, corresponding resource pools, used for the first type of UE and the second type of UE to carry out the sidelink transmission respectively. Specifically, a mode 3 resource pool (first resource pool) may be configured for mode 3, and a mode 4 resource pool (second resource pool) may be configured for mode 4. In order to improve resource utilization efficiency and avoid resource dispersion, in the prior art, the first resource pool and the second resource pool may have a part of shared resources. In this case, the base station may schedule the first type of UE of mode 3 to dynamically use the shared resource to carry out the sidelink transmission.

However, since the base station is not able to know the resource occupation status when the second type of UE autonomously carries out the sidelink transmission, when the base station allocates the part of the shared resources to the first type of UE, the allocated part of the shared resources may collide with the resources currently occupied by the second type of UE, thereby reducing the efficiency of information transmission and affecting the user experience.

### SUMMARY OF THE INVENTION

According to one aspect of the present invention, a resource configuration method is provided, the method being performed by a base station, and comprising: configuring a first resource pool, with the first resource pool being used for information transmission of a first type of UE in a sidelink transmission mode, where the first type of UE carries out a sidelink transmission by base station scheduling; configuring a second resource pool, with the second resource pool being used for information transmission of a second type of UE in a sidelink transmission mode, where the second type of UE autonomously carries out the sidelink transmission, and the first resource pool and the second resource pool are orthogonal to each other.

According to another aspect of the present invention, a resource scheduling method is provided, the method being performed by a base station, and comprising: allocating a plurality of candidate resources for a sidelink transmission to a first type of UE, where the first type of UE carries out the sidelink transmission by base station scheduling; transmitting scheduling information about the plurality of candidate resources to the first type of UE.

According to another aspect of the present invention, a resource scheduling method performed by a first type of UE is provided, where the first type of UE carries out a sidelink transmission by base station scheduling, the method comprising: receiving a plurality of candidate resources allocated by a base station for the sidelink transmission; carrying out the sidelink transmission with one of the plurality of candidate resources.

According to another aspect of the present invention, a resource scheduling method performed by a first type of UE is provided, where the first type of UE carries out a sidelink transmission by base station scheduling, the method comprising: receiving a first resource allocated by a base station for the sidelink transmission; determining whether the first resource collides with a second resource used by a second type of UE for carrying out the sidelink transmission, where the second type of UE autonomously carries out the sidelink transmission; transmitting collision indication information when the first resource collides with the second resource.

According to another aspect of the present invention, a resource scheduling method performed by a first type of UE is provided, where the first type of UE carries out a sidelink transmission by base station scheduling, the method comprising: receiving a first resource allocated by a base station for the sidelink transmission; determining whether the first resource collides with a second resource used by a second type of UE for carrying out the sidelink transmission, where the second type of UE autonomously carries out the sidelink transmission; the first type of UE autonomously selecting a third resource different from the second resource to carry out the sidelink transmission when the first resource collides with the second resource.

According to another aspect of the present invention, a resource scheduling method performed by a second type of UE is provided, where the second type of UE autonomously carries out a sidelink transmission, the method comprising: receiving collision indication information transmitted by a first type of UE, where the first type of UE carries out the sidelink transmission by base station scheduling through a first resource, and the collision indication information indicates that the first resource collides with the second resource used by the second type of UE for carrying out the sidelink transmission; reselecting resources for the sidelink transmission.

According to another aspect of the present invention, a base station is provided, comprising: a first configuring unit for configuring a first resource pool, the first resource pool being used for information transmission of a first type of UE in a sidelink transmission mode, where the first type of UE carries out a sidelink transmission by base station scheduling; a second configuring unit for configuring a second resource pool, the second resource pool being used for information transmission of a second type of UE in a sidelink transmission mode, where the second type of UE autonomously carries out the sidelink transmission, and the first resource pool and the second resource pool are orthogonal to each other.

According to another aspect of the present invention, a base station is provided, comprising: an allocating unit, configured to allocate, to the first type of UE, a plurality of candidate resources for a sidelink transmission, where the first type of UE carries out the sidelink transmission by base station scheduling; a transmitting unit, configured to transmit scheduling information about the plurality of candidate resources to the first type of UE.

According to another aspect of the present invention, a user equipment is provided, the user equipment being a first type of UE, and the first type of UE carries out a sidelink transmission by base station scheduling, comprising: a receiving unit, configured to receive a plurality of resources allocated by a base station for the sidelink transmission; a transmission unit, configured to carry out the sidelink transmission with one of the plurality of candidate resources.

According to another aspect of the present invention, a user equipment is provided, the user equipment being a first type of UE, and the first type of UE carries out a sidelink transmission by base station scheduling, comprising: a receiving unit, configured to receive a first resource allocated by a base station for the sidelink transmission; a determining unit, configured to determine whether the first resource collides with a second resource used by a second type of UE for the sidelink transmission, where the second type of UE autonomously carries out the sidelink transmission; a transmitting unit, configured to transmit collision indication information when the first resource collides with the second resource.

According to another aspect of the present invention, a user equipment is provided, the user equipment being a first type of UE, and the first type of UE carries out a sidelink transmission by base station scheduling, comprising: a receiving unit, configured to receive a first resource allocated by a base station for the sidelink transmission; a determining unit, configured to determine whether the first resource collides with a second resource used by a second type of UE for the sidelink transmission, where the second type of UE autonomously carries out the sidelink transmission; a selecting unit, configured to automatically select a third resource different from the second resource to carry out the sidelink transmission when the first resource collides with the second resource.

According to another aspect of the present invention, a user equipment is provided, the user equipment being a second type of UE, and the second type of UE autonomously carries out a sidelink transmission, comprising: a receiving unit, configured to receive collision indication information transmitted by a first type of UE, where the first type of UE carries out the sidelink transmission by base station scheduling through a first resource, and the collision indication information indicates that the first resource collides with the second resource used by the second type of UE for carrying out the sidelink transmission; a selecting unit, configured to reselect resources for the sidelink transmission.

With the resource configuring and scheduling method, the base station, and the user equipment according to the above aspects of the present invention, resource collision between the first type of UE that carries out a sidelink transmission by base station scheduling and the second type of UE that autonomously carries out the sidelink transmission may be effectively avoided by means of pre-collision avoidance or post-collision processing, thus improving the efficiency of information transmission and improving the user experience.

### BRIEF DESCRIPTION OF THE DRAWINGS

The above and other objects, features and advantages of the present invention will become more apparent by describing the embodiments of the present invention in detail in conjunction with the drawings.

FIG. 1 shows a flow chart of a resource configuring method according to one embodiment of the present invention;

FIG. 2 shows a flow chart of a resource scheduling method according to one embodiment of the present invention;

FIG. 3 shows a schematic diagram of a transmitting manner of base station scheduling information according to an embodiment of the present invention, where FIG. 3(a) shows a schematic diagram of DCI transmitting that multiplexes a sidelink scheduling timeline of R-14, FIG. 3(b) shows a schematic diagram of DCI transmitting when a delay between a candidate resource and DCI that indicates the candidate resource is a fixed value, and FIG. 3(c) shows a schematic diagram DCI transmitting when the delay between the candidate resource and the DCI that indicates the candidate resource is a dynamically adjusted value;

FIG. 4 shows a flow chart of a resource scheduling method according to one embodiment of the present invention;

FIG. 5 shows a flowchart of a resource scheduling method according to one embodiment of the present invention;

FIG. 6 shows a flowchart of a resource scheduling method according to one embodiment of the present invention;

FIG. 7 shows a flowchart of a resource scheduling method according to one embodiment of the present invention;

FIG. 8 shows a flowchart of a resource scheduling method according to one embodiment of the present invention;

FIG. 9 shows a block diagram of a base station according to one embodiment of the present invention;

FIG. 10 shows a block diagram of a base station according to one embodiment of the present invention;

FIG. 11 shows a block diagram of a user equipment according to one embodiment of the present invention;

FIG. 12 shows a block diagram of a user equipment according to one embodiment of the present invention;

FIG. 13 shows a block diagram of a user equipment according to one embodiment of the present invention;

FIG. 14 shows a block diagram of a user equipment according to one embodiment of the present invention;

FIG. 15 shows a diagram of an example of a hardware structure of a base station and a user equipment involved in one implementation of the present invention.

### DESCRIPTION OF THE EMBODIMENTS

A resource configuring and scheduling method, a base station, and a user equipment according to embodiments of the present invention will be described below with reference to the drawings. In the drawings, the same reference numerals always refer to the same elements. It should be understood that the embodiments described herein are illustrative only and are not intended to limit the scope of the present invention. Moreover, UE described herein may include various types of user equipment, for example, mobile terminals (or referred to as mobile stations) or fixed terminals. However, for convenience, the UE and user equipment may sometimes be used interchangeably.

In communication systems, there is a PC5 interface that supports device to device communications. As described above, a first resource pool allocated by a base station to a first type of UE and a second resource pool allocated by the base station to a second type of UE may have a part of shared resources, but this resource allocating and scheduling manner cannot avoid the situation in which the resources used by the first type of UE may collide with resources currently occupied by the second type of UE when carrying out sidelink transmission, thereby affecting a transmission effect of sidelink information.

A resource configuring and scheduling method, a base station, and a user equipment of embodiments of the present invention will be described below with reference to the drawings.

A resource configuring method according to one embodiment of the present invention will be described below with reference to FIG. 1. FIG. 1 shows a flow diagram of a resource configuring method 100 of one embodiment of the present invention, where the method is performed by a base station.

As shown in FIG. 1, in step S101, a first resource pool is configured, where the first resource pool is used for information transmission of a first type of UE in a sidelink transmission mode, the first type of UE carries out a sidelink transmission by base station scheduling.

In the embodiments of the present invention, the sidelink may be equivalent to the terminal direct link. As described above, the first type of UE is a UE in range of mode 3 of a PC5 interface, the resources for the sidelink information transmission of the first type of UE are scheduled by the base station. For example, the first type of UE may be a UE in a radio resource control (RRC) connected state.

In step S102, a second resource pool is configured, where the second resource pool is used for information transmission of a second type of UE in the sidelink transmission mode, the second type of UE autonomously carries out the sidelink transmission, and the first resource pool and the second resource pool are orthogonal to each other. As also described above, the second type of UE is a UE in range of mode 4 of the PC5 interface, and the resources for the sidelink information transmission of the second type of UE are allocated by the second type of UE autonomously. For example, the second type of UE may be a UE in an RRC idle state and/or a UE using a vehicle-to-specific target (V2X) communication dedicated carrier.

In the embodiments of the present invention, since the first resource pool and the second resource pool configured by the base station are orthogonal to each other, the first resource pool and the second resource pool do not have shared resources, so that the resources allocated by the base station to the first type of UE and the resources autonomously selected by the second type of UE do not overlap, thereby avoiding resource collision between the two types of UE.

It should be noted that in the embodiment shown in FIG. 1, there is no order limitation between step S101 and step S102. For example, step S101 may be performed first, and then step S102 may be performed, and vice versa. Of course, step S101 and step S102 may also be performed simultaneously.

Alternatively, the base station may configure a specific UE to be the first type of UE or the second type of UE.

According to the resource configuring method provided by the embodiments of the present invention, the first resource pool and the second resource pool may be configured to be orthogonal to each other, so that the first resource pool and the second resource pool do not have shared resources, thereby avoiding the resource collision between the first type of UE and the second type of UE during the sidelink transmission.

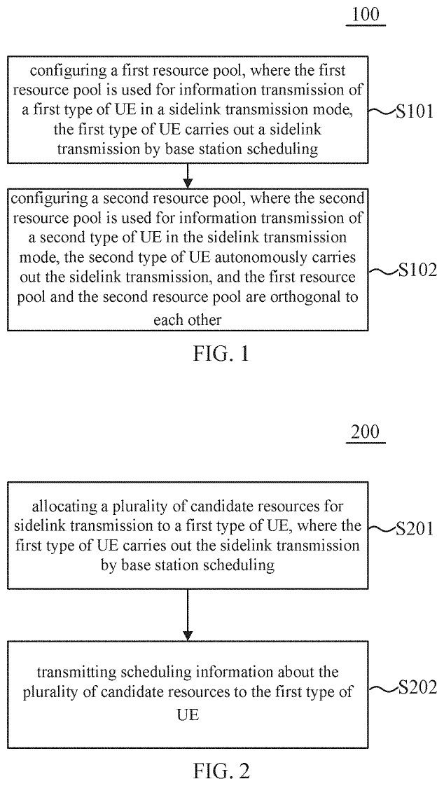

A resource scheduling method according to another embodiment of the present invention will be described below with reference to FIG. 2. FIG. 2 shows a flow diagram of a resource scheduling method 200 of another embodiment of the present invention, where the method is performed by a base station.

As shown in FIG. 2, in step S201, a plurality of candidate resources for sidelink transmission are allocated to a first type of UE, where the first type of UE carries out the sidelink transmission by base station scheduling.

Specifically, the base station may allocate a plurality of candidate resources to the first type of UE for one transport block (TB) or one transmission of semi-persistent scheduling (SPS), and the plurality of allocated candidate resources may be selected within the range of a shared resources between a first resource pool for the first type of UE and a second resource pool for a second type of UE.

In step S202, scheduling information about the plurality of candidate resources is transmitted to the first type of UE, so that the first type of UE carries out the sidelink transmission with one of the plurality of candidate resources. The plurality of candidate resources allocated by the base station to the first type of UE may be transmitted through signaling of a physical layer, or may be transmitted through signaling of a higher layer such as the data link layer or the network layer.

When the base station allocates the plurality of candidate resources to the first type of UE through signaling of the physical layer, the scheduling information about the plurality of candidate resources may be transmitted through a plurality of pieces of downlink control information (DCI), where each piece of DCI indicates the scheduling information of one candidate resource, and the plurality of pieces of DCI may be in a plurality of consecutive time slots, respectively. Specifically, when the base station allocates the plurality of candidate resources for one SPS, the scheduling information may be transmitted by scrambling a plurality of pieces of DCI with the same vehicle-to-vehicle (V2V) communications SPS-RNTI. In addition, the base station may also transmit DCI with a plurality of resource allocation fields through a new DCI design to schedule the plurality of candidate resources, where each field indicates a location of one candidate resource.

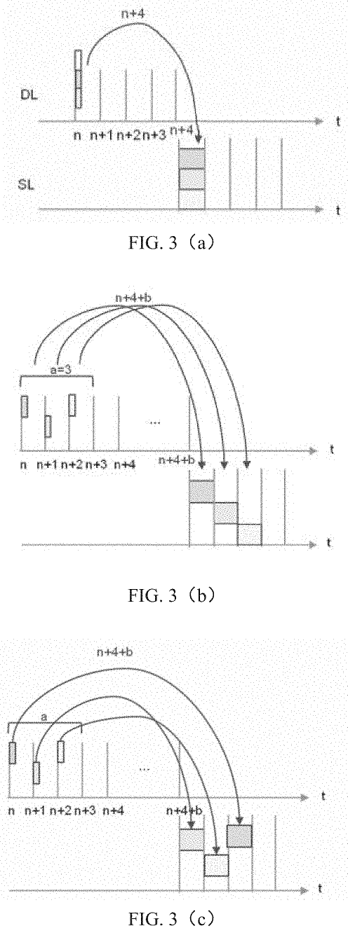

FIG. 3 shows a schematic diagram of a specific transmitting manner in which a base station transmits the scheduling information about the plurality of candidate resources through a plurality of pieces of DCI in the embodiments of the present invention. FIG. 3(a) shows a schematic diagram of DCI transmitting that multiplexes a sidelink scheduling timeline of R-14. In FIG. 3(a), in a frequency division duplex (FDD) mode, DCI scheduling information transmitted on a n-th time slot (TTI) in downlink will schedule resources on time slots that have fixed delays to it. For example, in one example of the present invention, the DCI scheduling information on the n-th time slot may schedule resources on a n+4-th slot. Correspondingly, in a time division duplex (TDD) mode, a similar mode may also be adopted for resource scheduling. Thus, when the base station transmits the scheduling information about the plurality of candidate resources through a plurality of pieces of DCI on one time slot, the first type of UE will decode the plurality of pieces of DCI in the same time slot.

FIG. 3(b) shows a schematic diagram of DCI transmitting when a delay between a candidate resource and DCI that indicates the candidate resource is a fixed value. In the embodiments of the present invention, the delay between any one piece of the downlink control information for indicating the candidate resources and any one of the candidate resources may be greater than a minimum required value, where the minimum required value may be a fixed time slot value as mentioned in FIG. 3(a), for example 4 time slots. In FIG. 3(b), b in the delay b+4 between the candidate resource and the DCI that indicates the candidate resource may be pre-configured as a fixed value. In addition, according to that shown in FIG. 3(b), there may also be a preset value a such that the scheduling information about the a candidate resources is transmitted through the a pieces of downlink control information in a consecutive time slots, where each piece of downlink control information is in one of the a consecutive time slots, and in FIG. 3(b), a=3. Alternatively, a delay between a first scheduled candidate resource (n+4+b) and last transmitted DCI (n+a) is greater than a processing time of the first type of UE, such that the first type of UE may be guaranteed to carry out the sidelink transmission with the resources scheduled by the base station after receiving and having processed all pieces of DCI. Here, both a and b may be configured by the base station. Alternatively, both a and b may be positive integers, and b [symbol] a. According to FIG. 3(b), in the frequency division duplex (FDD) mode, the DCI scheduling information transmitted on the n-th time slot (TTI) in downlink will schedule resources on a (n+4)+b-th time slot. In addition, in the time division duplex (TDD) mode, a similar mode may also be adopted for resource scheduling.

Correspondingly, on the side of the first type of UE, the first type of UE may decode all piece of DCI within the preset value a and obtain the plurality of candidate resources allocated by the base station, from its first received piece of DCI scrambled with V2V SPS-RNTI. In addition, alternatively, the first type of UE may also learn whether the transmission of the plurality of candidate resources has been completed by acquiring an additional transmission indicator on the DCI at the time of decoding, and when the transmission indicator indicates that the transmission has been completed, the first type of UE will decode all pieces of previous DCI as candidate resources allocated by the base station. For example, the base station may indicate whether the transmission of the candidate resources has been completed in a manner of adding 1 bit as the transmission indicator on the DCI. If the value of the 1-bit transmission indicator added to the DCI is 1, it indicates that the transmission of the allocated candidate resources has not been completed; and if the value of the 1-bit transmission indicator added to the DCI is 0, it indicates that the transmission of the allocated candidate resources has been completed, and the first type of UE may process the scheduling information transmitted by all pieces of previous DCI as candidate resources. An indication method of the transmission indicator of the DCI above is only an example, and in practical applications, any manner may be adopted to indicate whether the transmission of the DCI has been completed. In this case, the first type of UE may decode a plurality of pieces of DCI located in different time slots, respectively.

FIG. 3(c) shows a schematic diagram of DCI transmitting when the delay between the candidate resource and the DCI that indicates the candidate resource is a dynamically adjusted value. In the embodiments of the present invention, the delay between any one piece of the downlink control information for indicating the candidate resources and any one of the candidate resources may be greater than the minimum required value, where the minimum required value may be a fixed time slot value as mentioned in FIG. 3(a), for example 4 time slots. In FIG. 3(c), the b in the delay b+4 between the candidate resource and the DCI that indicates the candidate resource may be dynamically adjusted. In addition, according to that shown in FIG. 3(c), there may also be a preset value a such that the scheduling information about the a candidate resources is transmitted through the a pieces of downlink control information in a consecutive time slots, where each pieces of downlink control information is in one of the a consecutive time slots, and in FIG. 3(c), a=3. Alternatively, the delay between the first scheduled candidate resource and the last transmitted DCI (n+a) may be greater than the processing time of the first type of UE, such that the first type of UE may be guaranteed to carry out the sidelink transmission with the resources scheduled by the base station after receiving and having processed all pieces of DCI. Here, both a and b may be configured by the base station. Alternatively, both a and b may be positive integers, and b [symbol] a. According to FIG. 3(c), in the frequency division duplex (FDD) mode, the DCI scheduling information transmitted on the n-th time slot (TTI) in downlink will schedule resources on the (n+4)+b-th time slot. In addition, in the time division duplex (TDD) mode, a similar mode may also be adopted for resource scheduling. Since the b is not a fixed value here, a value of b configured on each piece of DCI may be notified by additional delay indication information (for example, a delay indicator) on the DCI delivered by the base station. For example, the value of b may be indicated by L bits. When L is 2, it may be set that bits “00” indicate the case where b=0, bits “01” indicate the case where b=1, bits “10” indicate the case where b=2, and bits “11” indicate the case where b=3. A delay indication method of the value of b described above is only an example, and in practical applications, any manner may be adopted to indicate the value of b.

Correspondingly, on the side of the first type of UE, the first type of UE may decode all piece of DCI within the preset value a and obtain the plurality of candidate resources allocated by the base station, from its first received piece of DCI scrambled with V2V SPS-RNTI. In addition, alternatively, the first type of UE may also learn whether the transmission of the plurality of candidate resources has been completed by acquiring the additional transmission indicator on the DCI at the time of decoding, and when the transmission indicator indicates that the transmission has been completed, the first type of UE will decode all pieces of previous DCI as candidate resources allocated by the base station. For example, the base station may indicate whether the transmission of the candidate resources has been completed in a manner of adding 1 bit as the transmission indicator on the DCI. If the value of the 1-bit transmission indicator added to the DCI is 1, it indicates that the transmission of the allocated candidate resources has not been completed; and if the value of the 1-bit transmission indicator added to the DCI is 0, it indicates that the transmission of the allocated candidate resources has been completed, and the first type of UE may process the scheduling information transmitted by all pieces of previous DCI as candidate resources. The indication method of the transmission indicator of the DCI above is only an example, and in practical applications, any manner may be adopted to indicate whether the transmission of the DCI has been completed. In this case, the first type of UE may decode a plurality of pieces of DCI located in the same or different time slots, respectively.

The example in which the plurality of candidate resources allocated by the base station to the first type of UE are transmitted through signaling of the physical layer is described above with reference to FIG. 3. In practical applications, as described above, the plurality of candidate resources allocated by the base station may also be transmitted through higher layer signaling such as a DL data layer or a MAC CE layer. For example, a physical downlink shared channel (PDSCH) that includes scheduling information about the sidelink candidate resources may be indicated by the DCI scrambled with V2V SPS-RNTI, so that the first type of UE obtains the scheduling information of the candidate resources by decoding information on a corresponding channel. This scheduling information may be indicated in a mode of bit map or a mode of time-frequency resource location.

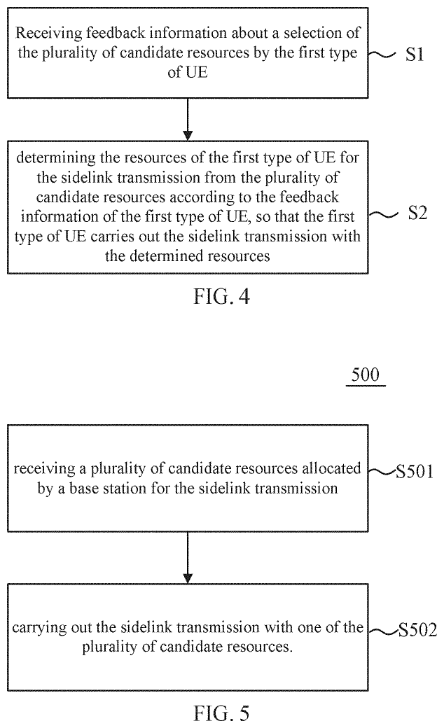

In another embodiment of the present invention, after the base station transmits the scheduling information about the plurality of candidate resources to the first type of UE in step S202, steps S1 and S2 shown in FIG. 4 may be further included to receive feedback information of the first type of UE, and to determine the sidelink transmission resources of the first type of UE according to the feedback information. FIG. 4 shows a flow chart of a resource scheduling method in another embodiment of the present invention, where the method is performed by the base station.

As shown in FIG. 4, in step S1, feedback information about a selection of the plurality of candidate resources by the first type of UE is received. Alternatively, the feedback information is a resource selected by the first type of UE, or a resource not selected by the first type of UE.

In one embodiment of the present invention, the first type of UE may feed back the selected or unselected resource information to the base station through the physical layer signaling or higher layer signaling. The feedback may be carried out at a feedback information position corresponding to downlink control information indicating the selected and/or unselected candidate resources, when the first type of UE feeds back through the physical layer signaling. Specifically, the feedback may be carried out through an acknowledgment/non-acknowledgment (ACK/NACK) signaling at the feedback information position corresponding to each piece of DCI. When the feedback information at the feedback information position corresponding to specific piece of DCI is the acknowledgment (ACK), it represents that the resources indicated by this piece of DCI may be selected; when the feedback information at the feedback information position corresponding to the specific piece of DCI is the non-acknowledgment (NACK), it represents that the candidate resources indicated by this piece of DCI are not selected. In addition, in another embodiment of the present invention, the first type of UE may also feed back information through the higher layer signaling. For example, signaling transmission may be carried out by multiplexing an uplink scheduling request mechanism. For another example, the information feedback may be carried out at the same time of a physical uplink shared channel (PUSCH) transmission configured by the base station, where the PUSCH may be configured together with the allocated plurality of candidate resources when the base station allocates the plurality of candidate resources for the sidelink transmission to the first type of UE.

In step S2 shown in FIG. 4, after the base station receives the feedback information of the first type of UE, the base station may determine the resources of the first type of UE for the sidelink transmission from the plurality of candidate resources according to the feedback information of the first type of UE. Alternatively, the base station may determine the candidate resources which are not occupied from the plurality of candidate resources according to the feedback information of a certain first type of UE, so that the unoccupied resources may be scheduled to other first type of UE.

In another embodiment of the present invention, the first type of UE may decide whether to transmit the feedback information to the base station according to a type of information transmitted by the sidelink transmission. When the information of the first type of UE transmitted by the sidelink transmission is one-time information, the first type of UE may not transmit the feedback information to the base station, and autonomously select resources for the sidelink transmission from the plurality of candidate resources scheduled by the base station. In addition, alternatively, when the first type of UE carries out the semi-persistent scheduling (SPS) transmission, since the resources allocated in one transmission of SPS may be periodically used (i.e., may be used for multiple times), downlink control information (DCI) is not required to be delivered for UE in each transmission time interval (TTI), thereby reducing overhead of control signaling. Therefore, at this time, the first type of UE may transmit the feedback information to the base station, and resources for SPS transmission may be selected by the base station. Whether the first type of UE transmits the feedback information to the base station may be configured by the base station according to the type of information transmitted by the sidelink transmission.

A flow chart of a resource scheduling method performed by the base station in one embodiment of the present invention is described above with reference to FIG. 2-FIG. 4. In the above embodiments, the sidelink transmission resources of the first type of UE are scheduled by the base station, and may be finally determined according to the feedback information of the first type of UE. Moreover, in another embodiment of the present invention shown in FIG. 2, the first type of UE may also autonomously select resources for the sidelink transmission according to the plurality of candidate resources allocated by the base station, to carry out the sidelink transmission. Specifically, after decoding and obtaining the plurality of candidate resources indicated in the DCI, the first type of UE may carry out monitoring and autonomously select resources with less interference from all candidate resources for the sidelink transmission. In one embodiment of the invention, the first type of UE may select resources with least interference based on received signal strength indication (RSSI) measurements. In another embodiment of the present invention, the first type of UE may check occupied resources in Resource Allocation (SA), and carries out reference signal received power (RSRP) measurements on the occupied resources. Since resources with higher received power in the occupied resources represent being occupied by near-field users, these resources cannot be selected and will be discarded. Therefore, by presetting a threshold, the first type of UE may also discard candidate resources with the received power exceed the threshold. Alternatively, when all the candidate resources cannot be selected, the first type of UE may carry out a resource reselection and carry out the sidelink transmission by increasing the threshold. Alternatively, the first type of UE may also randomly select resources from all resources that are not discarded to carry out the sidelink transmission. In addition, alternatively, the first type of UE may also select the resource with a minimum RSRP measurement value to carry out the sidelink transmission according to measurement result of the RSRP. The above selection manners of the candidate resources are only examples. In practical applications, any resource selection manner may be adopted to select resources for the sidelink transmission.

With the resource scheduling method according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

A flow chart of a resource scheduling method performed by the base station is described above with reference to FIG. 2. Accordingly, a resource scheduling method performed by a first type of UE according to one embodiment of the present invention will be described below with reference to FIG. 5. FIG. 5 shows a flowchart of a resource scheduling method 500 of one embodiment of the present invention. The first type of UE carries out a sidelink transmission by base station scheduling.

As shown in FIG. 5, in step S501, a plurality of candidate resources allocated by a base station for the sidelink transmission are received.

Specifically, the base station may allocate a plurality of candidate resources to the first type of UE for one transport block (TB) or semi-persistent scheduling (SPS), and the plurality of allocated candidate resources may be selected within the range of a shared resources between a first resource pool for the first type of UE and a second resource pool for a second type of UE.

In one embodiment of the present invention, the base station may transmit scheduling information about the plurality of candidate resources to the first type of UE. The plurality of candidate resources allocated by the base station to the first type of UE may be transmitted through signaling of a physical layer, or may be transmitted through signaling of a higher layer such as the data link layer or the network layer.

When the base station allocates the plurality of candidate resources to the first type of UE through signaling of the physical layer, the scheduling information about the plurality of candidate resources may be transmitted through a plurality of pieces of downlink control information (DCI), where each piece of DCI indicates the scheduling information of one candidate resource, and the a plurality of pieces of DCI may be in a plurality of consecutive time slots, respectively. Specifically, when the base station allocates the plurality of candidate resources for one SPS, the scheduling information may be transmitted by scrambling a plurality of pieces of DCI with the same vehicle-to-vehicle (V2V) communications SPS-RNTI. In addition, the base station may also transmit DCI with a plurality of resource allocation fields through a new DCI design to schedule the plurality of candidate resources, where each field indicates a location of one candidate resource.

In practical applications, as described above, the plurality of candidate resources allocated by the base station may also be transmitted through higher layer signaling such as a DL data layer or a MAC CE layer. For example, the base station may utilize physical downlink shared channel (PDSCH) that includes scheduling information about the sidelink candidate resources indicated by the DCI scrambled with V2V SPS-RNTI, such that the first type of UE obtains the scheduling information of the candidate resources by decoding information on a corresponding channel. This scheduling information may be indicated in a mode of bit map or a mode of time-frequency resource location.

In one embodiment of the present invention, after receiving the scheduling information about the plurality of candidate resources allocated by the base station, the first type of UE may transmit feedback information about a selection of the plurality of candidate resources. Specifically, after decoding and obtaining the plurality of candidate resources indicated in the DCI, the first type of UE may carry out monitoring and select resources with less interference from all candidate resources to feed back to the base station, so that the base station receives the feedback information about the selection of the plurality of candidate resources of the first type of UE. In one embodiment of the invention, the first type of UE may select resources with least interference based on received signal strength indication (RSSI) measurements. In another embodiment of the present invention, the first type of UE may check occupied resources in a Resource Allocation (SA), and carries out reference signal received power (RSRP) measurements on the occupied resources. Since resources with higher received power in the occupied resources represent being occupied by near-field users, these resources cannot be selected and will be discarded. Therefore, by presetting a threshold, the first type of UE may also feed back the discarded candidate resources with the received power exceed the threshold to the base station. Alternatively, when all the candidate resources cannot be selected, the resources may be reselected and fed back to the base station by increasing the threshold. In addition, alternatively, the first type of UE may also randomly select resources for the sidelink transmission from all resources that are not discarded, and carry out the feedback. The above selection manners of the candidate resources are only examples. In practical applications, any resource selection manner may be adopted to feed back information to the base station.

In an embodiment of the present invention, the first type of UE may feed back the selected or unselected resource information to the base station through the physical layer signaling or higher layer signaling. The feedback may be carried out at a feedback information position corresponding to downlink control information indicating the selected and/or unselected candidate resources, when the first type of UE feeds back through the physical layer signaling. Specifically, the feedback may be carried out through an acknowledgment/non-acknowledgment signaling at the feedback information position corresponding to each piece of DCI. When the feedback information at the feedback information position corresponding to specific piece of DCI is the acknowledgment, it represents that the resources indicated by this piece of DCI may be selected; when the feedback information at the feedback information position corresponding to the specific piece of DCI is the non-acknowledgment, it represents that the candidate resources indicated by this piece of DCI are not selected. In addition, in another embodiment of the present invention, the first type of UE may also feed back information through the higher layer signaling. For example, signaling transmission may be carried out by multiplexing an uplink scheduling request mechanism, and the information feedback may be carried out at the same time of a physical uplink shared channel (PUSCH) transmission configured by the base station.

Furthermore, in another embodiment of the present invention, the first type of UE may decide whether to transmit the feedback information to the base station according to a type of information transmitted by the sidelink transmission. When the information of the first type of UE for the sidelink transmission is one-time information, the first type of UE may not transmit the feedback information to the base station, and autonomously select resources for the sidelink transmission from the plurality of candidate resources scheduled by the base station. In addition, alternatively, when the first type of UE carries out the semi-persistent scheduling (SPS) transmission, since the resources allocated in one transmission of SPS may be periodically used (i.e., may be used multiple times), it may transmit the feedback information to the base station, and resources for SPS transmission may be selected by the base station. Whether the first type of UE transmits the feedback information to the base station may be configured by the base station according to the type of information transmitted by the sidelink transmission.

In step S502, the sidelink transmission is carried out with one of the plurality of candidate resources.

Specifically, after the first type of UE transmits the feedback information to the base station and the base station receives the feedback information, the base station may determine, according to the feedback information of the first type of UE, the resources of the first type of UE for the sidelink transmission from the plurality of candidate resources, so that the first type of UE carries out the sidelink transmission with one of the plurality of candidate resources. Specifically, the base station may carry out a resource selection according to an interference strength of a resource in the selectable candidate resources that are fed back by the first type of UE, or it may randomly carry out the resource selection among the remaining resources apart from unselectable resources fed back by the first type of UE.

In another embodiment of the present invention, alternatively, the first type of UE may also autonomously select the resources for the sidelink transmission. Alternatively, the first type of UE may autonomously select the resources for the sidelink transmission from the plurality of candidate resources allocated by the base station, to carry out the sidelink transmission. Specifically, after decoding and obtaining the plurality of candidate resources indicated in the DCI, the first type of UE may carry out monitoring and autonomously select resources with less interference from all candidate resources for the sidelink transmission. In one embodiment of the invention, the first type of UE may select resources with least interference based on received signal strength indication (RSSI) measurements. In another embodiment of the present invention, the first type of UE may check occupied resources in Resource Allocation (SA), and carries out reference signal received power (RSRP) measurements on the occupied resources. Since resources with higher received power in the occupied resources represent being occupied by near-field users, these resources cannot be selected and will be discarded. Therefore, by presetting a threshold, the first type of UE may also discard candidate resources with the received power exceed the threshold. Alternatively, when all the candidate resources cannot be selected, the first type of UE may carry out a resource reselection and carry out the sidelink transmission by increasing the threshold. In addition, alternatively, the first type of UE may also randomly select resources from all resources that are not discarded to carry out the sidelink transmission. The above selection manners of the candidate resources are only examples. In practical applications, any resource selection manner may be adopted to select resources for the sidelink transmission.

With the resource scheduling method according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

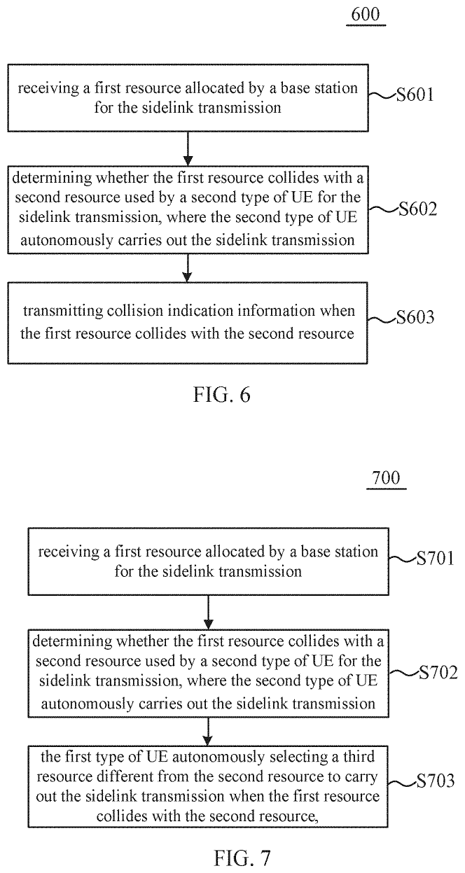

A resource scheduling method according to another embodiment of the present invention is described below with reference to FIG. 6. FIG. 6 shows a flow diagram of a resource scheduling method 600 of another embodiment of the present invention, where the method is performed by a first type of UE, the first type of UE carries out a sidelink transmission by base station scheduling.

As shown in FIG. 6, in step S601, a first resource allocated by a base station for the sidelink transmission is received. The first resource allocated by the base station to the first type of UE may be from shared resources of the first resource pool and a second resource pool.

In step S602, it is determined whether the first resource collides with a second resource used by a second type of UE for the sidelink transmission, where the second type of UE autonomously carries out the sidelink transmission.

Specifically, by monitoring the shared resources between the first resource pool and the second resource pool, the first type of UE may determine whether the first resource allocated by the base station is collided with the second resource used by the second type of UE, where whether the first type of UE carries out monitoring may be configured by the base station, or the first type of UE may always monitor by default. Alternatively, the first type of UE may check the first resource in Resource Allocation (SA) and carry out measurement of reference signal received power (RSRP). When the measured power is greater than a preset threshold, the first resource allocated by the base station may be considered being occupied. In addition, alternatively, the first type of UE may further determine whether the first resource is occupied by estimating whether an average RSSI is greater than a preset threshold. For example, the first type of UE may determine an occupancy of the first resource by determining whether the average RSSI per 100 ms in a monitoring window exceeds the preset threshold. In another embodiment of the present invention, the first type of UE may further determine whether the first resource is occupied by comprehensively considering results of the measurement of the RSRP and the measurement of the average RSSI. For example, the first type of UE may carry out an autonomous resource selection with reference to the second type of UE. Alternatively, the first type of UE may select resources with RSRP less than a certain preset threshold, measure the RSSI on these resources, and carry out a resource sorting according to RSSI values. Subsequently, the first type of UE may select, for example, a preset number or a predetermined percentage of resources with lower RSSI, and treat these resources as selectable resources. Thus, when the first resource allocated by the base station to the first type of UE overlaps with these selectable resources, the first type of UE considers that the first resource allocated by the base station is an available resource; otherwise, when the first resource allocated by the base station is not within a range of these selectable resources, the first type of UE considers that the first resource is already occupied.

In step S603, when the first resource collides with the second resource, collision indication information is transmitted. Alternatively, the first type of UE may transmit the collision indication information to the base station, so that the base station reallocates the resources of the first type of UE for the sidelink transmission. In addition, alternatively, the first type of UE may further transmit the collision indication information to the second type of UE, so that the second type of UE reselects the resources for the sidelink transmission.

Specifically, the first type of UE may feed back the selected or unselected resource information to the base station through the physical layer signaling or higher layer signaling. The feedback may be carried out at a feedback information position corresponding to downlink control information indicating the selected and/or unselected first resource, when the first type of UE feeds back through the physical layer signaling. Specifically, the feedback may be carried out through an acknowledgment/non-acknowledgment signaling at the feedback information position corresponding to this piece of DCI. When the feedback information at the feedback information position corresponding to specific piece of DCI is the acknowledgment, it represents that the first resource indicated by this piece of DCI may be selected; when the feedback information at the feedback information position corresponding to the specific piece of DCI is the non-acknowledgment, it represents that the first resource indicated by this piece of DCI is not selected.

In addition, in another embodiment of the present invention, the first type of UE may also feed back information through the higher layer signaling. For example, signaling transmission may be carried out by multiplexing an uplink scheduling request mechanism, and the information feedback may be carried out at the same time of a physical uplink shared channel (PUSCH) transmission configured by the base station. Specifically, a content of the collision indication information may include one or more of the following: indicating whether the allocated first resource is collided, the RSRP measurement of the resources allocated by SA, the RSSI measurement value, a reservation period of a same resource allocated by SA, a recommended resource location according to a monitoring result of the first type of UE, and the like.

In one embodiment of the present invention, the first type of UE may decide whether to transmit the collision indication information according to a type of information transmitted by the sidelink transmission. The first type of UE may not transmit the collision indication information and autonomously select the resources for the sidelink transmission when the information of the first type of UE transmitted by the sidelink transmission is one-time information. In addition, alternatively, when the first type of UE carries out SPS transmission, the first type of UE may transmit the collision indication information to the base station or the second type of UE, so that the base station selects the resources for the SPS transmission or the second type of UE reselects the resources on which it carries out the sidelink transmission. Whether the first type of UE transmits the collision indication information may be configured by the base station according to the type of information transmitted by the sidelink transmission.

With reference to the resource scheduling method of FIG. 6, it is illustrated in detail how to avoid an occurrence of the collision and reselect the resources when the resources allocated by the base station to the first type of UE have collided with the resources occupied by the second type of UE. In another embodiment of the present invention, the first type of UE may also adopt a manner of actively reporting resource occupancy to the base station before the collision, so that the base station avoids allocating to the first type of UE resources that may raise a collision when allocating resources, thereby avoiding a generation of collision. Specifically, the first type of UE may actively report the resource occupancy to the base station by continuous resource monitoring. The monitoring of the first type of UE may be pre-configured by the base station. A resource occupancy report transmitted by the first type of UE to the base station may be reported periodically or aperiodically through the higher layer signaling. For example, the first type of UE may periodically report the resource occupancy report together with its location information, or may report according to a requirement of the base station at any time. In another embodiment of the present invention, the resource occupancy report may also be monitored and reported through a Roadside Unit (RSU). Alternatively, the resource occupation reports reported by the first type of UE and/or the RSU may include one or more of the following: the RSRP measurement, the RSSI measurement value, the reservation period of the resources allocated by SA, the recommended resource location according to the monitoring result of the first type of UE and/or the RSU. In one embodiment of the present invention, the resource occupancy report of the first type of UE and/or the RSU includes a particular subset in their monitoring window or covers all monitored time-frequency resources, and the specific range of the report may be determined according to the configuration of the base station. In another embodiment of the present invention, when the resource collision has occurred, the resource occupancy report may be reported together with the foregoing collision indication information, so that the base station reconfigures the first resource used by the first type of UE.

With the resource scheduling method according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

A resource scheduling method according to one embodiment of the present invention is described below with reference to FIG. 7. FIG. 7 shows a flowchart of a resource scheduling method 700 of one an embodiment of the present invention, where the method is performed by a first type of UE, the first type of UE carried out a sidelink transmission by base station scheduling.

As shown in FIG. 7, in step S701, a first resource allocated by a base station for the sidelink transmission is received. The first resource allocated by the base station to the first type of UE may be from shared resources of a first resource pool and a second resource pool.

In step S702, it is determined whether the first resource collides with a second resource used by a second type of UE for the sidelink transmission, where the second type of UE autonomously carries out the sidelink transmission.

Specifically, by monitoring the shared resources between the first resource pool and the second resource pool, the first type of UE may determine whether the first resource allocated by the base station is collided with the second resource used by the second type of UE. Alternatively, the first type of UE may check the first resource in Resource Allocation (SA) and carry out measurement of reference signal received power (RSRP). When the measured power is greater than a preset threshold, the first resource allocated by the base station may be considered being occupied. In addition, alternatively, the first type of UE may further determine whether the first resource is occupied by estimating whether an average RSSI is greater than a preset threshold. For example, the first type of UE may determine an occupancy of the first resource by determining whether the average RSSI per 100 ms in a monitoring window exceeds the preset threshold. In another embodiment of the present invention, the first type of UE may further determine whether the first resource is occupied by comprehensively considering results of the measurement of the RSRP and the measurement of the average RSSI.

In step S703, when the first resource collides with the second resource, the first type of UE autonomously selects a third resource different from the second resource to carry out the sidelink transmission.

Specifically, the first type of UE may autonomously select the resources for the sidelink transmission to carry out the sidelink transmission. Specifically, the first type of UE may carry out resource monitoring and autonomously select resources with less interference from a plurality of selectable resources to carry out the sidelink transmission. In one embodiment of the invention, the first type of UE may select resources with least interference based on received signal strength indication (RSSI) measurements. In another embodiment of the present invention, the first type of UE may also check occupied resources in Resource Allocation (SA), and carries out reference signal received power (RSRP) measurements on the occupied resources to determine the resources that cannot be selected and discard them, and then randomly select resources from all resources that are not discarded to carry out the sidelink transmission. The above selection manners of the candidate resources are only examples. In practical applications, any resource selection manner may be adopted to select the resources for the sidelink transmission. Alternatively, the first type of UE may transmit the third resource that it autonomously selects for the sidelink transmission to the base station.

In one embodiment of the present invention, the first type of UE may use the third resource for the sidelink transmission for a period of time, and stop using the third resource for the sidelink transmission when a certain condition or some conditions are met, where the conditions may include: when a transmission of one transport block is completed by using the third resource, stopping using the third resource for the sidelink transmission; when an autonomous resource reselection of semi-persistent scheduling SPS is triggered, stopping using the third resource for the sidelink transmission; when a preset time or period lapses, stopping using the third resource for the sidelink transmission; and/or when the UE receives new scheduling resources from the base station, stopping using the third resource for the sidelink transmission. Alternatively, after the first type of UE stops using the third resource for the sidelink transmission, the sidelink transmission may be carried out by adopting the manner of base station scheduling again.

In one embodiment of the present invention, the third resource is selected from the second resource pool, and the second resource pool is associated with the first resource pool, where the first resource pool is used for information transmission of the first type of UE in a sidelink transmission mode, and the second resource pool is used for information transmission of the second type of UE in the sidelink transmission mode. The association between the second resource pool and the first resource pool may be configured by the base station. For example, when there are a plurality of first resource pools and a plurality of second resource pools, a certain first resource pool may be associated with one or more second resource pools. Alternatively, each of the first resource pools may also be in one-to-one correspondence with each of the second resource pools.

In one embodiment of the present invention, the autonomous selection of the third resource and the sidelink transmission may be carried out by using parameters of the semi-permanent scheduling configured by the base station.

In another embodiment of the present invention, the first type of UE may further transmit a scheduling abandonment report to the base station, and the scheduling abandonment report indicates that the first type of UE abandons the first resource scheduled by the base station. The scheduling abandonment report may transmit the scheduling abandonment report through lower layer or higher layer signaling such as a physical layer, a data link layer, or a network layer.

With the resource scheduling method according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

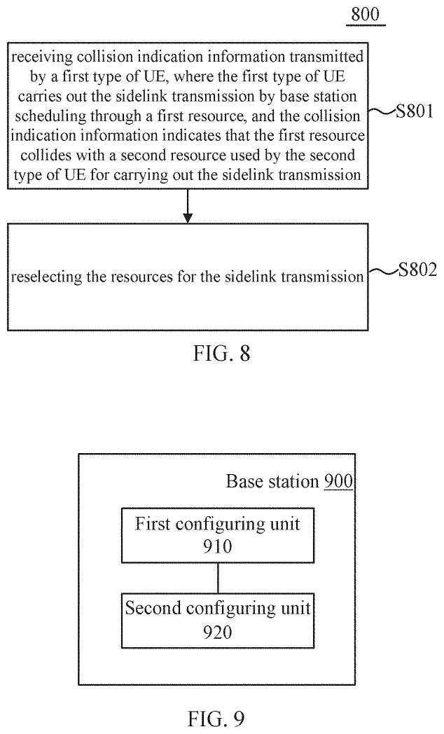

The resource scheduling method performed by the first type of UE according to one embodiment of the present invention has been described above with reference to FIG. 6. In step S603, when the collision indication information transmitted by the first type of UE is transmitted to the second type of UE, the second type of UE may be prompted to carry out the resource reselection to avoid collision occurrence. Accordingly, a resource scheduling method performed by a second type of UE according to one embodiment of the present invention will be described below with reference to FIG. 8. FIG. 8 shows a flow diagram of a resource scheduling method 800 of one embodiment of the present invention, where the second type of UE autonomously carries out a sidelink transmission.

As shown in FIG. 8, in step S801, collision indication information transmitted by a first type of UE is received, where the first type of UE carries out the sidelink transmission by base station scheduling through a first resource, and the collision indication information indicates that the first resource collides with a second resource used by the second type of UE for carrying out the sidelink transmission.

Alternatively, the first resource allocated by the base station to the first type of UE may be from shared resources of a first resource pool and a second resource pool. By monitoring the shared resources between the first resource pool and the second resource pool, the first type of UE may determine whether the first resource allocated by the base station is collided with the second resource used by the second type of UE. Alternatively, the first type of UE may check the first resource in Resource Allocation (SA) and carry out measurement of reference signal received power (RSRP). When the measured power is greater than a preset threshold, the first resource allocated by the base station may be considered being occupied. In addition, alternatively, the first type of UE may further determine whether the first resource is occupied by estimating whether an average RSSI is greater than a preset threshold. For example, the first type of UE may determine an occupancy of the first resource by determining whether the average RSSI per 100 ms in a monitoring window exceeds the preset threshold. In another embodiment of the present invention, the first type of UE may further determine whether the first resource is occupied by comprehensively considering results of the measurement of the RSRP and the measurement of the average RSSI. When the first resource collides with the second resource, the first type of UE will transmit the collision indication information to the second type of UE.

Specifically, the collision indication information may be a one-time SA message transmitted by the first type of UE to the second type of UE, and the SA message may be transmitted before or after a transmission of a first transport block. The SA message may include a signaling identifier, and the signaling identifier may be 1 bit. For example, when the value of the bit is 1, it may indicate the second type of UE to carry out the resource reselection, and when the value of the bit is 0, the second type of UE does not need to carry out the resource reselection. Moreover, the SA message may also include contents in a traditional SA message, for example, the SA message may include one or more of the following: a priority, a resource reservation, a frequency resource allocation (indicating a frequency domain location of resources of the first type of UE), a time interval between an initial transmission and a retransmission (indicating a time domain location of the resources of the first type of UE), MCS, a retransmission index, and reserved bits.

In one embodiment of the present invention, the first type of UE may decide whether to transmit the collision indication information according to a type of information transmitted by the sidelink transmission. The first type of UE may not transmit the collision indication information and autonomously select the resources for the sidelink transmission when the information of the first type of UE transmitted by the sidelink transmission is one-time information. In addition, alternatively, when the first type of UE carries out SPS transmission, the first type of UE may transmit the collision indication information to the second type of UE, so that the second type of UE reselects the resources on which it carries out the sidelink transmission. Whether the first type of UE transmits the collision indication information may be configured by the base station according to the type of information transmitted by the sidelink transmission.

In step S802, the resources for the sidelink transmission are reselected.

The second type of UE may autonomously select the resources from the allocated second resource pool, after receiving the collision indication information transmitted by the first type of UE, to change the resources of the second type of UE for the sidelink transmission.

With the resource scheduling method according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

A base station according to one embodiment of the present invention is described below with reference to FIG. 9. FIG. 9 shows a block diagram of a base station 900 according to one embodiment of the present invention. As shown in FIG. 9, the base station 900 includes a first configuring unit 910 and a second configuring unit 920. The base station 900 may further include other components in addition to these two units, however, since these components are not related to the content of the embodiments of the present invention, an illustration and description thereof are omitted here. Moreover, since the specific details of the operations described below performed by the base station 900 according to the embodiments of the present invention are the same as those described above with reference to FIG. 1, a repeated description of the same details is omitted herein to avoid repetition.

As shown in FIG. 9, the first configuring unit 910 configures a first resource pool, and the first resource pool is used for information transmission of a first type of UE in a sidelink transmission mode, where the first type of UE carries out the sidelink transmission by base station scheduling. As described above, the first type of UE is a UE in range of mode 3 of a PC5 interface, the resources for the sidelink information transmission of the first type of UE are scheduled by the base station. Optionally, the first type of UE may be a UE in a radio resource control (RRC) connected state.

The second configuring unit 920 configures a second resource pool, and the second resource pool is used for information transmission of a second type of UE in the sidelink transmission mode, where the second type of UE autonomously carries out the sidelink transmission, and the first resource pool and the second resource pool are orthogonal to each other. As also described above, the second type of UE is a UE in range of mode 4 of the PC5 interface, and the resources for the sidelink information transmission of the second type of UE are allocated by the second type of UE autonomously. Optionally, the second type of UE may be a UE in an RRC idle state and/or a UE using a vehicle-to-specific (V2X) target communication dedicated carrier.

In the embodiments of the present invention, since the first resource pool and the second resource pool configured by the base station 900 are orthogonal to each other, the first resource pool and the second resource pool do not have shared resources, so that resources allocated by the base station to the first type of UE and resources autonomously selected by the second type of UE do not overlap, thereby avoiding a resource collision between the two types of UE.

Alternatively, the base station 900 may configure a specific UE to be the first type of UE or the second type of UE.

According to the base station provided by the embodiments of the present invention, the first resource pool and the second resource pool may be configured to be orthogonal to each other, so that the first resource pool and the second resource pool do not have shared resources, thereby avoiding the resource collision between the first type of UE and the second type of UE during the sidelink transmission.

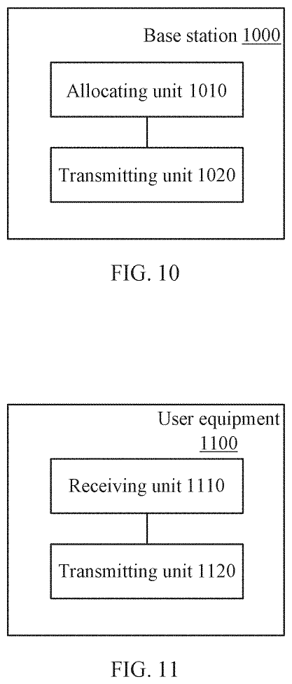

A base station according to another embodiment of the present invention is described below with reference to FIG. 10. FIG. 10 is a block diagram showing a base station 1000 according to one embodiment of the present invention. As shown in FIG. 10, the base station 1000 includes an allocating unit 1010 and a transmitting unit 1020. The base station 1000 may further include other components in addition to these two units, however, since these components are not related to the content of the embodiments of the present invention, an illustration and description thereof are omitted herein. Moreover, since the specific details of the operations described below performed by the base station 1000 according to the embodiments of the present invention are the same as those described above with reference to FIGS. 2-4, a repeated description of the same details is omitted herein to avoid repetition.

As shown in FIG. 10, the allocating unit 1010 allocates a plurality of candidate resources to a first type of UE for a sidelink transmission, where the first type of UE carries out the sidelink transmission by base station scheduling.

Specifically, the allocating unit 1010 may allocate a plurality of candidate resources to the first type of UE for one transport block (TB) or one transmission of semi-persistent scheduling (SPS), and these allocated candidate resources may be selected within the range of a shared resources between a first resource pool for the first type of UE and a second resource pool for a second type of UE.

The transmitting unit 1020 transmits scheduling information about the plurality of candidate resources to the first type of UE, so that the first type of UE carries out the sidelink transmission with one of the plurality of candidate resources. The plurality of candidate resources allocated by the transmitting unit 1020 to the first type of UE may be transmitted through signaling of a physical layer, or may be transmitted through signaling of a higher layer such as the data link layer or the network layer.

When the transmitting unit 1020 allocates the plurality of candidate resources to the first type of UE through signaling of the physical layer, the scheduling information about the plurality of candidate resources may be transmitted through a plurality of pieces of downlink control information (DCI), where each piece of DCI indicates the scheduling information of one candidate resource, and the a plurality of pieces of DCI may be in a plurality of consecutive time slots, respectively. Specifically, when allocating unit 1010 allocates a plurality of candidate resources for one SPS, the transmitting unit 1020 may transmit the scheduling information by scrambling a plurality of pieces of DCI with the same vehicle-to-vehicle (V2V) communications SPS-RNTI. In addition, the transmitting unit 1020 may also transmit DCI with a plurality of resource allocation fields through a new DCI design to schedule the plurality of candidate resources, where each field indicates a location of one candidate resource.

FIG. 3 shows a schematic diagram of a specific transmitting manner in which the transmitting unit 1020 transmits the scheduling information about the plurality of candidate resources through a plurality of pieces of DCI in the embodiments of the present invention. FIG. 3(a) shows a schematic diagram of DCI transmitting that multiplexes a sidelink scheduling timeline of R-14. In FIG. 3(a), in a frequency division duplex (FDD) mode, DCI scheduling information transmitted on a n-th time slot (TTI) in downlink will schedule resources on time slots that have fixed delays to it. For example, in one example of the present invention, the DCI scheduling information on the n-th time slot may schedule resources on a n+4-th slot. Correspondingly, in a time division duplex (TDD) mode, a similar mode may also be adopted for resource scheduling. Thus, when the base station transmits the scheduling information about the plurality of candidate resources through a plurality of pieces of DCI on one time slot, the first type of UE will decode a plurality of pieces of DCI in the same time slot.

FIG. 3(b) shows a schematic diagram of DCI transmitting when a delay between a candidate resource and DCI that indicates the candidate resource is a fixed value. In the embodiments of the present invention, the delay between any one piece of the downlink control information for indicating the candidate resources and any one of the candidate resources may be greater than a minimum required value, where the minimum required value may be a fixed time slot value as mentioned in FIG. 3(a), for example 4 time slots. In FIG. 3(b), b in the delay b+4 between the candidate resource and the DCI that indicates the candidate resource may be pre-configured as a fixed value. In addition, according to that shown in FIG. 3(b), there may also be a preset value a such that the scheduling information about the a candidate resources is transmitted through the a pieces of downlink control information in a consecutive time slots, where each pieces of downlink control information is in one of the a consecutive time slots. Alternatively, a delay between a first scheduled candidate resource (n+4+b) and last transmitted DCI (n+a) is greater than a processing time of the first type of UE, such that the first type of UE may be guaranteed to carry out the sidelink transmission with the resources scheduled by the base station after receiving and having processed all pieces of DCI. Here, both a and b may be configured by the base station. Alternatively, both a and b may be positive integers, and b≥a. According to FIG. 3(b), in the frequency division duplex (FDD) mode, the DCI scheduling information transmitted on the n-th time slot (TTI) in downlink will schedule resources on a (n+4)+b-th time slot. In addition, in the time division duplex (TDD) mode, a similar mode may also be adopted for resource scheduling.

Correspondingly, on the side of the first type of UE, the first type of UE may decode all piece of DCI within the preset value a and obtain the plurality of candidate resources allocated by the base station, from its first received DCI scrambled with V2V SPS-RNTI. In addition, alternatively, the first type of UE may also learn whether the transmission of the plurality of candidate resources has been completed by acquiring an additional transmission indicator on the DCI at the time of decoding, and when the transmission indicator indicates that the transmission has been completed, the first type of UE will decode all pieces of previous DCI as candidate resources allocated by the base station. For example, the base station may indicate whether the transmission of the candidate resources has been completed in a manner of adding 1 bit as the transmission indicator on the DCI. If the value of the 1-bit transmission indicator added to the DCI is 1, it indicates that the transmission of the allocated candidate resources has not been completed; and if the value of the 1-bit transmission indicator added to the DCI is 0, it indicates that the transmission of the allocated candidate resources has been completed, and the first type of UE may process the scheduling information transmitted by all pieces of previous DCI as candidate resources. An indication method of the transmission indicator of the DCI above is only an example, and in practical applications, any manner may be adopted to indicate whether the transmission of the DCI has been completed. In this case, the first type of UE may decode a plurality of pieces of DCI located in different time slots, respectively.

FIG. 3(c) shows a schematic diagram of DCI transmitting when the delay between the candidate resource and the DCI that indicates the candidate resource is a dynamically adjusted value. In the embodiments of the present invention, the delay between any one piece of the downlink control information for indicating the candidate resources and any one of the candidate resources may be greater than the minimum required value, where the minimum required value may be a fixed time slot value as mentioned in FIG. 3(a), for example 4 time slots. In FIG. 3(c), the b in the delay b+4 between the candidate resource and the DCI that indicates the candidate resource may be dynamically adjusted. In addition, according to that shown in FIG. 3(c), there may also be a preset value a such that the scheduling information about the a candidate resources is transmitted through the a pieces of downlink control information in a consecutive time slots, where each pieces of downlink control information is in one of the a consecutive time slots. Alternatively, the delay between the first scheduled candidate resource and the last transmitted DCI (n+a) may be greater than the processing time of the first type of UE, such that the first type of UE may be guaranteed to carry out the sidelink transmission with the resources scheduled by the base station after receiving and having processed all pieces of DCI. Here, both a and b may be configured by the base station. Alternatively, both a and b may be positive integers, and b [symbol] a. According to FIG. 3(c), in the frequency division duplex (FDD) mode, the DCI scheduling information transmitted on the n-th time slot (TTI) in downlink will schedule resources on the (n+4)+b-th time slot. In addition, in the time division duplex (TDD) mode, a similar mode may also be adopted for resource scheduling. Since the b is not a fixed value here, a value of b configured on each piece of DCI may be notified by additional delay indication information (for example, a delay indicator) on the DCI delivered by the base station. For example, the value of b may be indicated by L bits. When L is 2, it may be set that bits “00” indicate the case where b=0, bits “01” indicate the case where b=1, bits “10” indicate the case where b=2, and bits “11” indicate the case where b=3. A delay indication method of the value of b described above is only an example, and in practical applications, any manner may be adopted to indicate the value of b.

Correspondingly, on the side of the first type of UE, the first type of UE may decode all piece of DCI within the preset value a and obtain the plurality of candidate resources allocated by the base station, from its first received DCI scrambled with V2V SPS-RNTI. In addition, alternatively, the first type of UE may also learn whether the transmission of the plurality of candidate resources has been completed by acquiring the additional transmission indicator on the DCI at the time of decoding, and when the transmission indicator indicates that the transmission has been completed, the first type of UE will decode all pieces of previous DCI as candidate resources allocated by the base station. For example, the base station may indicate whether the transmission of the candidate resources has been completed in a manner of adding 1 bit as the transmission indicator on the DCI. If the value of the 1-bit transmission indicator added to the DCI is 1, it indicates that the transmission of the allocated candidate resources has not been completed; and if the value of the 1-bit transmission indicator added to the DCI is 0, it indicates that the transmission of the allocated candidate resources has been completed, and the first type of UE may process the scheduling information transmitted by all pieces of previous DCI as candidate resources. The indication method of the transmission indicator of the DCI above is only an example, and in practical applications, any manner may be adopted to indicate whether the transmission of the DCI has been completed. In this case, the first type of UE may decode a plurality of pieces of DCI located in the same or different time slots, respectively.

The example in which the plurality of candidate resources allocated by the base station to the first type of UE are transmitted through signaling of the physical layer is described above with reference to FIG. 3. In practical applications, as described above, the plurality of candidate resources may also be transmitted through higher layer signaling such as a DL data layer or a MAC CE layer. For example, a physical downlink shared channel (PDSCH) that includes scheduling information about the sidelink candidate resources may be indicated by the DCI scrambled with V2V SPS-RNTI, so that the first type of UE obtains the scheduling information of the candidate resources by decoding information on a corresponding channel. This scheduling information may be indicated in a mode of bit map or a mode of time-frequency resource location.

In another embodiment of the present invention, after the transmitting unit 1020 transmits the scheduling information about the plurality of candidate resources to the first type of UE, the base station 1000 may further include a receiving unit (not shown) to receive feedback information about a selection of the plurality of candidate resources by the first type of UE. Alternatively, the feedback information is a resource selected by the first type of UE, or a resource not selected by the first type of UE.

In one embodiment of the present invention, the first type of UE may feed back the selected or unselected resource information to the base station 1000 through the physical layer signaling or higher layer signaling. The feedback may be carried out at a feedback information position corresponding to downlink control information indicating the selected and/or unselected candidate resources when the first type of UE feeds back through the physical layer signaling. Specifically, the feedback may be carried out through an acknowledgment/non-acknowledgment signaling at the feedback information position corresponding to each piece of DCI. When the feedback information at the feedback information position corresponding to specific piece of DCI is the acknowledgment, it represents that the resources indicated by this piece of DCI may be selected; when the feedback information at the feedback information position corresponding to the specific piece of DCI is the non-acknowledgment, it represents that the candidate resources indicated by this piece of DCI are not selected. In addition, in another embodiment of the present invention, the first type of UE may also feed back information through the higher layer signaling. For example, signaling transmission may be carried out by multiplexing an uplink scheduling request mechanism. For another example, the information feedback may be carried out at the same time of a physical uplink shared channel (PUSCH) transmission configured by the base station, where the PUSCH may be configured together with the allocated plurality of candidate resources when the base station allocates the plurality of candidate resources for the sidelink transmission to the first type of UE.

After the base station 1000 receives the feedback information of the first type of UE, the transmitting unit 1020 may determine the resources of the first type of UE for the sidelink transmission from the plurality of candidate resources according to the feedback information of the first type of UE and then transmit. Alternatively, the base station may determine the candidate resources which are not occupied from the plurality of candidate resources according to the feedback information of a certain first type of UE, so that the unoccupied resources may be scheduled to other first type of UE.

In one embodiment of the present invention, the first type of UE may decide whether to transmit the feedback information to the base station according to a type of information transmitted by the sidelink transmission. When the information of the first type of UE transmitted by the sidelink transmission is one-time information, the first type of UE may not transmit the feedback information to the base station, and autonomously select resources for the sidelink transmission from the plurality of candidate resources scheduled by the base station. In addition, alternatively, when the first type of UE carries out the semi-persistent scheduling (SPS) transmission, since the resources allocated in one transmission of SPS may be periodically used (i.e., may be used for multiple times), downlink control information (DCI) is not required to be delivered for UE in each transmission time interval (TTI), thereby reducing overhead of control signaling. Therefore, at this time, the first type of UE may transmit the feedback information to the base station, and resources for SPS transmission may be selected by the base station. Whether the first type of UE transmits the feedback information to the base station may be configured by the base station according to the type of information transmitted by the sidelink transmission.

In another embodiment of the present invention, optionally, the first type of UE may also autonomously select resources for the sidelink transmission according to the plurality of candidate resources allocated by the base station to carry out the sidelink transmission. Specifically, after decoding and obtaining the plurality of candidate resources indicated in the DCI, the first type of UE may carry out monitoring and autonomously select resources with less interference from all candidate resources for the sidelink transmission. In one embodiment of the invention, the first type of UE may select resources with least interference based on received signal strength indication (RSSI) measurements. In another embodiment of the present invention, the first type of UE may check occupied resources in Resource Allocation (SA), and carries out reference signal received power (RSRP) measurements on the occupied resources. Since resources with higher received power in the occupied resources represent being occupied by near-field users, these resources cannot be selected and will be discarded. Therefore, by presetting a threshold, the first type of UE may also discard candidate resources with the received power exceed the threshold. Alternatively, when all the candidate resources cannot be selected, the first type of UE may carry out a resource reselection and carry out the sidelink transmission by increasing the threshold. Alternatively, the first type of UE may also randomly select resources from all resources that are not discarded to carry out the sidelink transmission. In addition, the first type of UE may also select the resource with a minimum RSRP measurement value to carry out the sidelink transmission according to measurement result of the RSRP. The above selection manners of the candidate resources are only examples. In practical applications, any resource selection manner may be adopted to select resources for the sidelink transmission.

With the base station according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

The block diagram of the base station 1000 according to the embodiments of the present invention has been described above with reference to FIG. 10. Correspondingly, a UE according to one embodiment of the present invention will be described below with reference to FIG. 11. FIG. 11 is a block diagram showing a UE 1100 according to one embodiment of the present invention, the UE being a first type of UE, and the first type of UE carries out a sidelink transmission by base station scheduling. As shown in FIG. 11, the UE 1100 includes a receiving unit 1110 and a transmission unit 1120. The UE 1100 may further include other components in addition to these two units, however, since these components are not related to the content of the embodiments of the present invention, an illustration and description thereof are omitted herein. Moreover, since the specific details of the operations described below performed by the UE 1100 according to the embodiments of the present invention are the same as those described above with reference to FIG. 5, a repeated description of the same details is omitted herein to avoid repetition.

As shown in FIG. 11, the receiving unit 1110 receives a plurality of candidate resources allocated by a base station for a sidelink transmission.

Specifically, the base station may allocate a plurality of candidate resources to the first type of UE for one transport block (TB) or semi-persistent scheduling (SPS), and these allocated candidate resources may be selected from the within the range of a shared resources between a first resource pool for the first type of UE and a second resource pool for a second type of UE.

In one embodiment of the present invention, the base station may transmit scheduling information about the plurality of candidate resources to the first type of UE. The plurality of candidate resources allocated by the base station to the first type of UE may be transmitted through signaling of a physical layer, or may be transmitted through signaling of a higher layer such as the data link layer or the network layer.

In addition, in practical applications, as described above, the plurality of candidate resources allocated by the base station may also be transmitted through higher layer signaling such as a DL data layer or a MAC CE layer. For example, the base station may utilize physical downlink shared channel (PDSCH) that includes scheduling information about the sidelink candidate resources indicated by the DCI scrambled with V2V SPS-RNTI, such that the first type of UE obtains the scheduling information of the candidate resources by decoding information on a corresponding channel. This scheduling information may be indicated in a mode of bit map or a mode of time-frequency resource location.

In one embodiment of the present invention, after the receiving unit 1110 receives the scheduling information about the plurality of candidate resources allocated by the base station, the first type of UE 1100 may transmit feedback information about a selection of the plurality of candidate resources. Specifically, after decoding and obtaining the plurality of candidate resources indicated in the DCI, the first type of UE may carry out monitoring and select resources with less interference from all candidate resources to feed back to the base station, so that the base station receives the feedback information about the selection of the plurality of candidate resources of the first type of UE. In one embodiment of the invention, the first type of UE may select resources with least interference based on received signal strength indication (RSSI) measurements. In another embodiment of the present invention, the first type of UE may check occupied resources in Resource Allocation (SA), and carries out reference signal received power (RSRP) measurements on the occupied resources. Since resources with higher received power in the occupied resources represent being occupied by near-field users, these resources cannot be selected and will be discarded. Therefore, by presetting a threshold, the first type of UE may also feed back the discarded candidate resources with the received power exceeds the threshold to the base station. Alternatively, when all the candidate resources cannot be selected, the resources may be reselected and fed back to the base station by increasing the threshold. In addition, alternatively, the first type of UE may also randomly select resources for the sidelink transmission from all resources that are not discarded, and carry out the feedback. The above selection manners of the candidate resources are only examples. In practical applications, any resource selection manner may be adopted to feed back information to the base station.

In one embodiment of the present invention, the first type of UE 1100 may feed back the selected or unselected resource information to the base station through the physical layer signaling or higher layer signaling. The feedback may be carried out at a feedback information position corresponding to downlink control information indicating the selected and/or unselected candidate resources when the first type of UE feeds back through the physical layer signaling. Specifically, the feedback may be carried out through an acknowledgment/non-acknowledgment signaling at the feedback information position corresponding to each piece of DCI. When the feedback information at the feedback information position corresponding to specific piece of DCI is the acknowledgment, it represents that the resources indicated by this piece of DCI may be selected; when the feedback information at the feedback information position corresponding to the specific piece of DCI is the non-acknowledgment, it represents that the candidate resources indicated by this piece of DCI are not selected. In addition, in another embodiment of the present invention, the first type of UE may also feed back information through the higher layer signaling. For example, signaling transmission may be carried out by multiplexing an uplink scheduling request mechanism, and the information feedback may be carried out at the time of a physical uplink shared channel (PUSCH) transmission configured by the base station.

In addition, in another embodiment of the present invention, the first type of UE 1100 may decide whether to transmit the feedback information to the base station according to a type of information transmitted by the sidelink transmission. The first type of UE may not transmit the feedback information to the base station, and autonomously select resources for the sidelink transmission from the plurality of candidate resources scheduled by the base station, when the information of the first type of UE transmitted by the sidelink transmission is one-time information. In addition, alternatively, when the first type of UE carries out the semi-persistent scheduling (SPS) transmission, since the resources allocated in one SPS may be periodically used (i.e., may be used multiple times), it may transmit the feedback information to the base station, and resources for SPS transmission may be selected by the base station. Whether the first type of UE transmits the feedback information to the base station may be configured by the base station according to the type of information transmitted by the sidelink transmission.

The transmission unit 1120 carries out the sidelink transmission with one of the plurality of candidate resources.

Specifically, after receiving the feedback information of the UE1100 of the first type, the base station may determine, according to the feedback information of the first type of UE, the resources of the first type of UE for the sidelink transmission, from the plurality of candidate resources, so that the transmission unit 1120 of the first type of UE 1100 carries out the sidelink transmission with one of the plurality of candidate resources. Specifically, the base station may carry out a resource selection according to an interference strength of a resource in the selectable candidate resources that are fed back by the first type of UE, or it may randomly carry out the resource selection among the remaining resources apart from unselectable resources fed back by the first type of UE.

In another embodiment of the present invention, alternatively, the first type of UE 1100 may also autonomously select the resources for the sidelink transmission. Alternatively, the first type of UE may autonomously select the resources for the sidelink transmission from the plurality of candidate resources allocated by the base station to carry out the sidelink transmission with the transmission unit 1120. Specifically, after decoding and obtaining the plurality of candidate resources indicated in the DCI, the first type of UE may carry out monitoring and autonomously select resources with less interference from all candidate resources for the sidelink transmission. In one embodiment of the invention, the first type of UE may select resources with least interference based on received signal strength indication (RSSI) measurements. In another embodiment of the present invention, the first type of UE may check occupied resources in Resource Allocation (SA), and carries out reference signal received power (RSRP) measurements on the occupied resources. Since resources with higher received power in the occupied resources represent being occupied by near-field users, these resources cannot be selected and will be discarded. Therefore, by presetting a threshold, the first type of UE may also discard candidate resources with the received power exceed the threshold. Alternatively, when all the candidate resources cannot be selected, the first type of UE may carry out a resource reselection and carry out the sidelink transmission by increasing the threshold. In addition, alternatively, the first type of UE may also randomly select resources from all resources that are not discarded to carry out the sidelink transmission. The above selection manners of the candidate resources are only examples. In practical applications, any resource selection manner may be adopted to select resources for the sidelink transmission.

With the UE according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

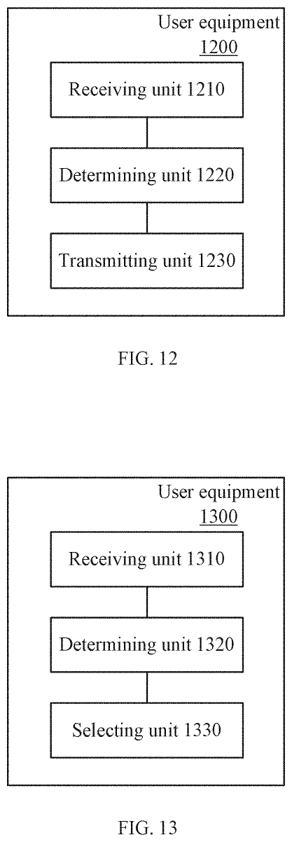

A UE according to another embodiment of the present invention is described below with reference to FIG. 12. FIG. 12 is a block diagram showing a UE 1200 according to another embodiment of the present invention, the UE 1200 being a first type of UE, and the first type of UE carries out a sidelink transmission by base station scheduling. As shown in FIG. 12, the UE 1200 includes a receiving unit 1210, a determining unit 1220, and a transmitting unit 1230. The UE 1200 may further include other components in addition to these three units, however, since these components are not related to the content of the embodiment of the present invention, an illustration and description thereof are omitted herein. Moreover, since the specific details of the operations described below performed by the UE 1200 according to the embodiments of the present invention are the same as those described above with reference to FIG. 6, a repeated description of the same details is omitted herein to avoid repetition.

As shown in FIG. 12, the receiving unit 1210 receives a first resource allocated by a base station for a sidelink transmission. The first resource allocated by the base station to the first type of UE may be from shared resources of a first resource pool and a second resource pool.

The determining unit 1220 determines whether the first resource collides with a second resource used by the second type of UE for the sidelink transmission, where the second type of UE autonomously carries out the sidelink transmission.

Specifically, by monitoring the shared resources between the first resource pool and the second resource pool, the determining unit 1220 may determine whether the first resource allocated by the base station is collided with the second resource used by the second type of UE, whether the first type of UE carries out monitoring may be configured by the base station, or the first type of UE may always monitor by default. Alternatively, the first type of UE may check the first resource in Resource Allocation (SA) and carry out measurement of reference signal received power (RSRP). When the measured power is greater than a preset threshold, the first resource allocated by the base station may be considered being occupied. In addition, alternatively, the first type of UE may further determine whether the first resource is occupied by estimating whether an average RSSI is greater than a preset threshold. For example, the first type of UE may determine an occupancy of the first resource by determining whether the average RSSI per 100 ms in a monitoring window exceeds the preset threshold. In another embodiment of the present invention, the first type of UE may further determine whether the first resource is occupied by comprehensively considering results of the measurement of the RSRP and the measurement of the average RSSI. For example, the first type of UE may carry out an autonomous resource selection with reference to the second type of UE. Alternatively, the first type of UE may select resources with RSRP less than a certain preset threshold, measure the RSSI on these resources, and carry out a resource sorting according to RSSI values. Subsequently, the first type of UE may select, for example, a preset number or a predetermined percentage of resources with lower RSSIs, and treat these resources as selectable resources. Thus, when the first resource allocated by the base station to the first type of UE overlaps with these selectable resources, the first type of UE considers that the first resource allocated by the base station is an available resource; otherwise, when the first resource allocated by the base station is not within a range of these selectable resources, the first type of UE considers that the first resource is already occupied.

When the first resource collides with the second resource, the transmitting unit 1230 transmits collision indication information is transmitted. Alternatively, the first type of UE may transmit the collision indication information to the base station, so that the base station reallocates the resources of the first type of UE for the sidelink transmission. In addition, alternatively, the first type of UE may further transmit the collision indication information to the second type of UE, so that the second type of UE reselects the resources for the sidelink transmission.

Specifically, the transmitting unit 1230 may feed back the selected or unselected resource information to the base station through the physical layer signaling or higher layer signaling. The feedback may be carried out at a feedback information position corresponding to downlink control information indicating the selected and/or unselected first resource when the first type of UE feeds back through the physical layer signaling. Specifically, the feedback may be carried out through an acknowledgment/non-acknowledgment signaling at the feedback information position corresponding to this piece of DCI. When the feedback information at the feedback information position corresponding to specific piece of DCI is the acknowledgment, it represents that the first resource indicated by this piece of DCI may be selected; when the feedback information at the feedback information position corresponding to the specific piece of DCI is the non-acknowledgment, it represents that the first resource indicated by this piece of DCI is not selected.

In addition, in another embodiment of the present invention, the transmitting unit 1230 may also feed back information through the higher layer signaling. For example, signaling transmission may be carried out by multiplexing an uplink scheduling request mechanism, and the information feedback may be carried out at the same time of a physical uplink shared channel (PUSCH) transmission configured by the base station. Specifically, a content of the collision indication information may include one or more of the following: indicating whether the allocated first resource is collided, the RSRP measurement of the resources allocated by SA, the RSSI measurement value, a reservation period of a same resource allocated by SA, a recommended resource location according to a monitoring result of the first type of UE, and the like.

In one embodiment of the present invention, the transmitting unit 1230 may decide whether to transmit the collision indication information according to a type of information transmitted by the sidelink transmission. The first type of UE may not transmit the collision indication information and autonomously select the resources for the sidelink transmission when the information of the first type of UE transmitted by the sidelink transmission is one-time information. In addition, optionally, when the first type of UE carries out SPS transmission, the first type of UE may transmit the collision indication information to the base station or the second type of UE, so that the base station selects the resources for the SPS transmission or the second type of UE reselects the resources on which it carries out the sidelink transmission. Whether the first type of UE transmits the collision indication information may be configured by the base station according to the type of information transmitted by the sidelink transmission.

With reference to a structure of the UE 1200 in FIG. 12, it is illustrated in detail how to avoid an occurrence of the collision and reselect the resources when the resources allocated by the base station to the first type of UE 1200 have collided with the resources occupied by the second type of UE. In another embodiment of the present invention, the first type of UE 1200 may also adopt a manner of actively reporting resource occupancy to the base station before the collision, so that the base station avoids allocating to the first type of UE 1200 resources that may raise a collision when allocating resources, thereby avoiding a generation of collision. Specifically, the transmitting unit 1230 of the first type of UE may actively report the resource occupancy to the base station by continuous resource monitoring. Specifically, the monitoring of the first type of UE may be pre-configured by the base station. A resource occupancy report transmitted by the transmitting unit 1230 to the base station may be reported periodically or aperiodically through the higher layer signaling. For example, the transmitting unit 1230 may periodically report the resource occupancy report together with its location information, or may report according to a requirement of the base station. In another embodiment of the present invention, the resource occupancy report may also be monitored and reported through a Roadside Unit (RSU). Alternatively, the resource occupation reports reported by the transmitting unit 1230 of the first type of UE and/or the RSU may include one or more of the following: the RSRP measurement, the RSSI measurement value, the reservation period of the resources allocated by SA, the recommended resource location according to the monitoring result of the first type of UE and/or the RSU. In one embodiment of the present invention, the resource occupancy report of the transmitting unit 1230 of the first type of UE and/or the RSU includes a particular subset in their monitoring window or covers all monitored time-frequency resources, and the range of the report may be determined according to the configuration of the base station. In one embodiment of the present invention, when the resource collision has occurred, the resource occupancy report may be reported together with the foregoing collision indication information, so that the base station reconfigures the first resource used by the first type of UE.

With the UE according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

A UE according to one embodiment of the present invention is described with reference to FIG. 13. FIG. 13 is a block diagram showing a UE 1300 according to one embodiment of the present invention, the UE 1300 being a first type of UE, and the first type of UE carries out a sidelink transmission by base station scheduling. As shown in FIG. 13, the UE 1300 includes a receiving unit 1310, a determining unit 1320, and a selecting unit 1330. The UE 1300 may further include other components in addition to these three units, however, since these components are not related to the content of the embodiment of the present invention, an illustration and description thereof are omitted herein. Moreover, since the specific details of the operations described below performed by the UE 1300 according to the embodiments of the present invention are the same as those described above with reference to FIG. 7, a repeated description of the same details is omitted herein to avoid repetition.

As shown in FIG. 13, the receiving unit 1310 receives a first resource allocated by a base station for the sidelink transmission. The first resource allocated by the base station to the first type of UE may be from shared resources of a first resource pool and a second resource pool.

The determining unit 1320 determines whether the first resource collides with a second resource used by a second type of UE for the sidelink transmission, where the second type of UE autonomously carries out the sidelink transmission.

Specifically, by monitoring the shared resources between the first resource pool and the second resource pool, the determining unit 1320 may determine whether the first resource allocated by the base station is collided with the second resource used by the second type of UE. Alternatively, the determining unit 1320 may check the first resource in Resource Allocation (SA) and carry out measurement of reference signal received power (RSRP). When the measured power is greater than a preset threshold, the first resource allocated by the base station may be considered being occupied. In addition, alternatively, the determining unit 1320 may further determine whether the first resource is occupied by estimating whether an average RSSI is greater than a preset threshold. For example, the determining unit 1320 may determine an occupancy of the first resource by determining whether the average RSSI per 100 ms in a monitoring window exceeds the preset threshold. In another embodiment of the present invention, the determining unit 1320 may further determine whether the first resource is occupied by comprehensively considering results of the measurement of the RSRP and the measurement of the average RSSI.

When the first resource collides with the second resource, the selecting unit 1330 of the first type of UE autonomously selects a third resource different from the second resource to carry out the sidelink transmission.

Specifically, the selecting unit 1330 may autonomously select the resources for the sidelink transmission to carry out the sidelink transmission. Specifically, the first type of UE may carry out resource monitoring and autonomously select resources with less interference from a plurality of selectable resources to carry out the sidelink transmission. In one embodiment of the invention, the selecting unit 1330 may select resources with least interference based on received signal strength indication (RSSI) measurements. In another embodiment of the present invention, the selecting unit 1330 may also check occupied resources in Resource Allocation (SA), and carries out reference signal received power (RSRP) measurements on the occupied resources to determine the resources that cannot be selected and discard them, and then randomly select resources from all resources that are not discarded to carry out the sidelink transmission. The above selection manners of the candidate resources are only examples. In practical applications, any resource selection manner may be adopted to select the resources for the sidelink transmission. Alternatively, the selecting unit 1330 may transmit the third resource that it autonomously selects for the sidelink transmission to the base station.

In one embodiment of the present invention, the first type of UE may use the third resource for the sidelink transmission for a period of time, and stop using the third resource for the sidelink transmission when a certain condition or some conditions are met, where the conditions may include: when a transmission of one transport block is completed by using the third resource, stopping using the third resource for the sidelink transmission; when an autonomous resource reselection of semi-persistent scheduling SPS is triggered, stopping using the third resource for the sidelink transmission; when a preset time or period lapses, stopping using the third resource for the sidelink transmission; and/or when the UE receives new scheduling resources from the base station, stopping using the third resource for the sidelink transmission. Alternatively, after the first type of UE stops using the third resource for the sidelink transmission, the sidelink transmission may be carried out by adopting the manner of base station scheduling again.

In one embodiment of the present invention, the third resource is selected from the second resource pool, and the second resource pool is associated with the first resource pool, where the first resource pool is used for information transmission of the first type of UE in a sidelink transmission mode, and the second resource pool is used for information transmission of the second type of UE in the sidelink transmission mode. The association between the second resource pool and the first resource pool may be configured by the base station. For example, when there are a plurality of first resource pools and a plurality of second resource pools, a certain first resource pool may be associated with one or more second resource pools. Alternatively, each of the first resource pools may also be in one-to-one correspondence with each of the second resource pools.

In one embodiment of the present invention, the first type of UE may carry out the autonomous selection of the third resource and the sidelink transmission by using parameters of the semi-permanent scheduling configured by the base station.

In another embodiment of the present invention, the first type of UE may further transmit a scheduling abandonment report to the base station, and the scheduling abandonment report indicates that the first type of UE abandons the first resource scheduled by the base station. The scheduling abandonment report may transmit the scheduling abandonment report through lower layer or higher layer signaling such as a physical layer, a data link layer, or a network layer.

With the UE according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

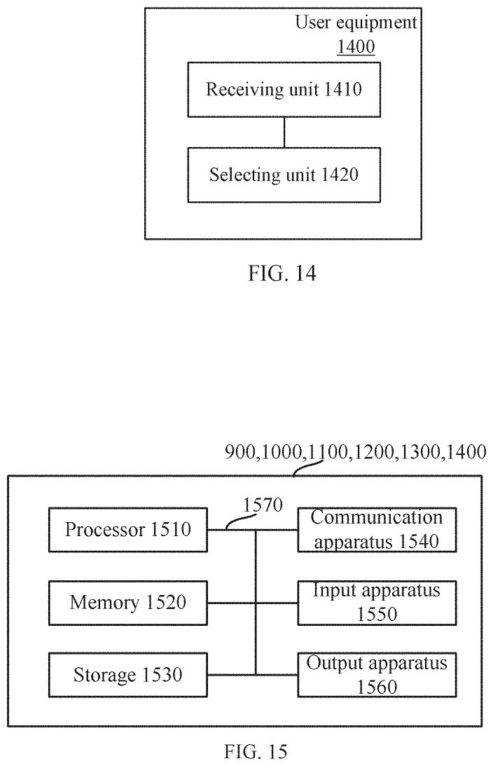

The structure of the first type of UE 1200 according to one embodiment of the present invention has been described above with reference to FIG. 12. When the collision indication information transmitted by the transmitting unit 1230 of the first type of UE 1200 is transmitted to the second type of UE, the second type of UE may be prompted to carries out the resource reselection to avoid collision occurrence. Accordingly, a user equipment, which is a second type of UE, according to one embodiment of the present invention, will be described below with reference to FIG. 14. FIG. 14 is a block diagram showing a UE 1400 according to one embodiment of the present invention, the UE 1400 being a second type of UE, and the second type of UE carries out a sidelink transmission autonomously. As shown in FIG. 14, the UE 1400 includes a receiving unit 1410 and a selecting unit 1420. The UE 1400 may include other components in addition to these two units, however, since these components are not related to the content of the embodiment of the present invention, an illustration and description thereof are omitted herein. Moreover, since the specific details of the operations described below performed by the UE 1400 according to the embodiments of the present invention are the same as those described above with reference to FIG. 8, a repeated description of the same details is omitted herein to avoid repetition.

As shown in FIG. 14, the receiving unit 1410 receives collision indication information transmitted by a first type of UE, where the first type of UE carries out the sidelink transmission by base station scheduling through a first resource, and the collision indication information indicates that the first resource collides with a second resource used by the second type of UE for carrying out the sidelink transmission.

Alternatively, the first resource allocated by the base station to the first type of UE may be from shared resources of a first resource pool and a second resource pool. By monitoring the shared resources between the first resource pool and the second resource pool, the first type of UE may determine whether the first resource allocated by the base station is collided with the second resource used by the second type of UE. Alternatively, the first type of UE may check the first resource in Resource Allocation (SA) and carry out measurement of reference signal received power (RSRP). When the measured power is greater than a preset threshold, the first resource allocated by the base station may be considered being occupied. In addition, alternatively, the first type of UE may further determine whether the first resource is occupied by estimating whether an average RSSI is greater than a preset threshold. For example, the first type of UE may determine an occupancy of the first resource by determining whether the average RSSI per 100 ms in a monitoring window exceeds the preset threshold. In another embodiment of the present invention, the first type of UE may further determine whether the first resource is occupied by comprehensively considering results of the measurement of the RSRP and the measurement of the average RSSI. When the first resource collides with the second resource, the first type of UE will transmit the collision indication information to the second type of UE.

Specifically, the collision indication information may be a one-time SA message transmitted by the first type of UE to the second type of UE, and the SA message may be transmitted before or after a transmission of a first transport block. The SA message may include a signaling identifier, and the signaling identifier may be 1 bit. For example, when the value of the bit is 1, it may indicate the second type of UE to carry out the resource reselection, and when the value of the bit is 0, the second type of UE does not need to carry out the resource reselection. Moreover, the SA message may also include contents in a traditional SA message, for example, the SA message may include one or more of the following: a priority, a resource reservation, a frequency resource allocation (indicating a frequency domain location of resources of the first type of UE), a time interval between an initial transmission and a retransmission (indicating a time domain location of the resources of the first type of UE), MCS, a retransmission index, and reserved bits.

In one embodiment of the present invention, the first type of UE may decide whether to transmit the collision indication information according to a type of information transmitted by the sidelink transmission. The first type of UE may not transmit the collision indication information and autonomously select the resources for the sidelink transmission when the information of the first type of UE transmitted by the sidelink transmission is one-time information. In addition, alternatively, when the first type of UE carries out SPS transmission, the first type of UE may transmit the collision indication information to the second type of UE, so that the second type of UE reselects the resources on which it carries out the sidelink transmission. Whether the first type of UE transmits the collision indication information may be configured by the base station according to the type of information transmitted by the sidelink transmission.

The selecting unit 1420 reselects the resources for the sidelink transmission.

After the receiving unit 1410 receives the collision indication information transmitted by the first type of UE, to change the resources of the second type of UE for the sidelink transmission, the selecting unit 1420 may autonomously select the resources from the allocated second resource pool.

With the UE according to the above aspects of the present invention, resource collision between the first type of UE that carries out the sidelink transmission by base station scheduling and the second type of UE that autonomously carries out the sidelink transmission can be effectively avoided, thus improving the efficiency of information transmission and improving the user experience.

<Hardware Structure>

Additionally, block diagrams used for the illustration of the above embodiments represent functional blocks in functional units. These functional blocks (components) are realized by any combination of hardware and/or software. In addition, the means for implementing the respective function blocks is not particularly limited. That is, the respective functional blocks may be realized by one apparatus that is physically and/or logically aggregated; or more than two apparatuses that are physically and/or logically separated may be directly and/or indirectly (e.g., wiredly and/or wirelessly) connected, and the respective functional blocks may be implemented by these apparatuses.

For example, a wireless base station or a user terminal, in an embodiment of the present invention can function as a computer that carries out the processes of the wireless communication method of the present invention. FIG. 15 is a diagram that shows an example of a hardware structure of the user device according to an embodiment of the present invention. The above described base stations 900, 1000 and user equipments 1100, 1200, 1300, 1400 may be physically constituted as a computer apparatus including a processor 1510, a memory 1520, a storage 1503, a communication apparatus 1540, an input apparatus 1550, an output apparatus 1560, a bus 1570 and so on.

It should be noted that, in the following description, the term “apparatus” may be interpreted as a circuit, a device, a unit or the like. The hardware constitution of the base stations 900, 1000 and user equipments 1100, 1200, 1300, 1400 may include one or more apparatuses shown in the figure, or may not include a part of the apparatuses.

For example, although only one processor 1510 is shown, a plurality of processors may be provided. Furthermore, processes may be performed by one processor, or processes may be performed either simultaneously or in sequence, or in different manners, by two or more processors. Additionally, the processor 1510 may be installed with one or more chips.

Respective functions of the base stations 900, 1000 and user equipments 1100, 1200, 1300, 1400 are implemented by, for example, reading predetermined software (program) onto hardware such as the processor 1510 and the memory 1520, so as to make the processor 1510 perform calculations, controlling the communication carried out by the communication apparatus 940, and controlling the reading and/or writing of data in the memory 1520 and the storage 1530.

The processor 1510 may control the whole computer by, for example, running an operating system. The processor 1510 may be configured with a central processing unit (CPU), which includes interfaces with peripheral apparatus, a control apparatus, a computing apparatus, a register and so on.

Furthermore, the processor 1510 reads programs (program codes), software modules, data or the like, from the storage 1530 and/or the communication apparatus 1540, into the memory 1520, and executes various processes according to them. As the programs, programs to allow a computer to execute at least part of the operations described in the above-described embodiments may be used. For example, the allocation unit 1010 of the base station 1000 can be implemented by a control program stored in the memory 1520 and operating by the processor 1510. For other functional blocks, the same can be achieved.

The memory 1520 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1520 may be referred to as a “register”, a “cache”, a “main memory” (primary storage apparatus) and so on. The memory 1520 can store executable programs (program codes), software modules and so on for implementing the radio communication methods according to embodiments of the present invention.

The storage 1530 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1530 may be referred to as a secondary storage apparatus.

The communication apparatus 1540 is hardware (transmitting/receiving device) for allowing inter-computer communication by using wired and/or wireless networks, and may be referred to as, for example, a network device, a network controller, a network card, a communication module and so on. The communication apparatus 1540 may include, but not limit to, a high frequency switch, a filter, a frequency synthesizer and so on. For example, the above-described transmission unit 1120 or the like may be implemented by the communication apparatus 1540.

The input apparatus 1550 is an input device for receiving input from the outside (for example, a keyboard, a mouse, a microphone, a switch, a button, a sensor or the like). The output apparatus 1560 is an output device for implementing output to the outside (for example, a display, a speaker, an LED (Light Emitting Diode) lamp, or the like). It should be noted that the input apparatus 1550 and the output apparatus 1560 may be provided in an integrated structure (for example, a touch panel).

Furthermore, these apparatus, including the processor 1510, the memory 1520 and so on are connected by the bus 1570 for communicating information. The bus 1570 may be formed with a single bus, or may be formed with buses that vary between apparatus.

Also, the base stations 900, 1000 and user equipments 1100, 1200, 1300, 1400 may include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1510 may be installed with at least one of these pieces of hardware.

(Variations)

It should be noted that the terms illustrated in the present specification and/or the terms required for the understanding of the present specification may be substituted with terms having the same or similar meaning. For example, a channel and/or a symbol may be a signal (signaling). In addition, the signal may be a message. A reference signal may be abbreviated as a RS (Reference Signal), and may be referred to as a pilot, a pilot signal and so on, depending on the standard applied. In addition, a component carrier (CC) may be referred to as a carrier frequency, a cell, a frequency carrier, or the like.

Further, the radio frame may be composed of one or more periods (frames) in the time domain. Each of the one or more periods (frames) constituting the radio frame may also be referred to as a subframe. Further, a subframe may be composed of one or more time slots in the time domain. The subframe may be a fixed length of time (eg, 1 ms) that is independent of the numerology.

Furthermore, a slot may be comprised of one or more symbols (OFDM (Orthogonal Frequency Division Multiplexing) symbols, SC-FDMA (Single Carrier Frequency Division Multiple Access) symbols, or the like) in the time domain. Furthermore, the slot may also be a time unit configured based on a parameter. Furthermore, a slot may also include multiple micro-slots. Each micro-slot may be comprised of one or more symbols in the time domain. Furthermore, a micro-slot may also be referred as a sub-slot.

A radio frame, a subframe, a slot, a micro-slot and a symbol all represent the time unit when transmitting signals. A radio frame, a subframe, a slot, a micro-slot and a symbol may also use other names that correspond to them. For example, one subframe may be referred to as a transmission time interval (TTI), a plurality of consecutive subframes may also be referred to as a TTI, and one slot or one micro-slot may also be referred to as a “TTI.” That is, the subframe and/or the TTI may be a subframe (1 ms) in existing LTE, may be a shorter period of time than 1 ms (for example, one to thirteen symbols), or may be a longer period of time than 1 ms. It should be noted that a unit indicating the TTI may also be referred to as a slot, a micro-slot, or the like instead of a subframe.

Here, the TTI refers to a minimum time unit of scheduling in radio communication, for example. For example, in LTE systems, a radio base station performs, for respective user equipment, the scheduling to assign radio resources (such as frequency bandwidths and transmission powers that can be used in the respective user equipment) in a unit of TTI. It should be noted that the definition of the TTI is not limited to this.

The TTI may be a transmission time unit for a channel-coded data packet (transmission block), a code block, and/or a codeword, or may be a processing unit for scheduling, link adaptation and so on. It should be noted that, when a TTI is given, a time interval (e.g., the number of symbols) actually mapped to a transmission block, a code block, and/or a codeword may be shorter than the TTI.

It should be noted that, when one slot or one micro-slot is called a TTI, more than one TTI (i.e., more than one slot or more than one micro-slot) may become a minimum time unit for scheduling. Furthermore, the number of slots (the number of micro-slots) constituting the minimum time unit for scheduling may be controlled.

A TTI having a time duration of 1 ms may be referred to as a normal TTI (TTI in LTE Rel. 8 to 12), a standard TTI, a long TTI, a normal subframe, a standard subframe, or a long subframe, or the like. A TTI that is shorter than a normal TTI may be referred to as a shortened TTI, a short TTI, a partial (or fractional) TTI, a shortened subframe, a short subframe, a micro-slot, a short micro-slot, or the like.

It should be noted that, a long TTI (e.g., a normal TTI, a subframe, etc.) may be replaced with a TTI having a time duration exceeding 1 ms, and a short TTI (e.g., a shortened TTI, etc.) may also be replaced with a TTI having a TTI duration which is shorter than that of the long TTI and exceeds 1 ms.

A resource block (RB) is a unit of resource allocation in the time domain and the frequency domain, and may include one or a plurality of consecutive subcarriers in the frequency domain. Also, an RB may include one or more symbols in the time domain, and may be one slot, one micro-slot, one subframe or one TTI duration. One TTI and one subframe each may be comprised of one or more resource blocks, respectively. It should be noted that one or more RBs may also be referred to as a physical resource block (PRB (Physical RB)), a Sub-Carrier Group (SCG), a Resource Element Group (REG), a PRG pair, an RB pair, and so on.

In addition, the resource block may also be composed of one or more resource elements (REs). For example, an RE can be a radio resource area of a subcarrier and a symbol.

It should be noted that the above-described structures of radio frames, subframes, slots, micro-slots, symbols and so on are simply examples. For example, configurations such as the number of subframes included in a radio frame, the number of slots of each subframe or radio frame, the number or micro-slots included in a slot, the number of symbols and RBs included in a slot or micro-slot, the number of subcarriers included in an RB, the number of symbols in a TTI, the symbol length, the cyclic prefix (CP) length and so on can be variously changed.

Also, the information, parameters and so on described in this specification may be represented in absolute values or in relative values with respect to predetermined values, or may be represented in other corresponding information. For example, radio resources may be indicated by predetermined indices. In addition, equations to use these parameters and so on may be different from those explicitly disclosed in this specification.

The names used for parameters and so on in this specification are not limited in any respect. For example, since various channels (PUCCH (Physical Uplink Control Channel), PDCCH (Physical Downlink Control Channel) and so on) and information elements can be identified by any suitable names, the various names assigned to these various channels and information elements are not limited in any respect.

The information, signals and so on described in this specification may be represented by using any one of various different technologies. For example, data, instructions, commands, information, signals, bits, symbols, chips and so on, which may be referenced throughout the herein-contained description, may be represented by voltages, currents, electromagnetic waves, magnetic fields or particles, optical fields or photons, or any combination of them.

Also, information, signals and so on can be output from higher layers to lower layers and/or from lower layers to higher layers. Information, signals and so on may be input and/or output via a plurality of network nodes.

The information, signals and so on that are input and /or output may be stored in a specific location (for example, in a memory), or may be managed in a management table. The information, signals and so on that are input and /or output may be overwritten, updated or appended. The information, signals and so on that are output may be deleted. The information, signals and so on that are input may be transmitted to other apparatus.

Reporting of information is by no means limited to the aspects/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBS) and so on), MAC (Medium Access Control) signaling and so on), and other signals and/or combinations of them.

It should be noted that physical layer signaling may also be referred to as L1/L2 (Layer 1/Layer 2) control information (L1/L2 control signals), L1 control information (L1 control signal) and so on. Also, RRC signaling may be referred to as “RRC message”, and can be, for example, an RRC connection setup message, RRC connection reconfiguration message, and so on. Also, MAC signaling may be reported using, for example, MAC control elements (MAC CE (Control Element)).

Software, whether referred to as software, firmware, middleware, microcode or hardware description language, or called by other names, should be interpreted broadly, to mean commands, command sets, codes, code segments, program codes, programs, subprograms, software modules, applications, software applications, software packages, routines, subroutines, objects, executable files, execution threads, steps, functions and so on.

Also, software, commands, information and so on may be transmitted or received via tranmission media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are included in the definition of transmission media.

The terms “system” and “network” as used herein are used interchangeably.

In the present specification, the terms “base station (BS)”, “radio base station”, “eNB”, “gNB”, “cell”, “sector”, “cell group”, “carrier” and “component carrier” may be used interchangeably. A base station may be referred to as a “fixed station”, “NodeB”, “eNodeB (eNB)”, “access point”, “transmission point”, “receiving point”, “femto cell”, “small cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

In the present specification, the terms “mobile station (MS)”, “user terminal”, “user equipment (UE)” and “terminal” may be used interchangeably. A base station may be referred to as a “fixed station”, “NodeB”, “eNodeB (eNB)”, “access point”, “transmission point” , “receiving point”, “femto cell”, “small cell” and so on.

Sometimes a mobile station is also called by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

Furthermore, the radio base stations in this specification may be replaced by user terminal. For example, each aspect/embodiment of the present invention may be applied to a configuration in which communication between a radio base station and a user terminal is replaced with communication among a plurality of user terminal (D2D (Device-to-Device)). In this case, user terminal may have the functions of the radio base stations described above. In addition, terms such as “uplink” and “downlink” may be replaced by “side.” For example, an uplink channel may be replaced by a side channel.

Likewise, the user terminal in this specification may be replaced by radio base stations. At this time, the function of the above-described user terminal can be regarded as a function of the wireless base station.

In the present specification, it is assumed that certain actions to be performed by base station may, in some cases, be performed by its higher node (upper node). In a network comprised of one or more network nodes with base stations, it is clear that various operations that are performed to communicate with terminals can be performed by base stations, one or more network nodes (for example, MMES (Mobility Management Entities), S-GW (Serving-Gateways), and so on)other than base stations, or combinations of them.

The respective aspects/embodiments illustrated in this specification may be used individually or in combinations, or may be switched and used during execution. The order of processes, sequences, flowcharts and so on of the respective aspects/embodiments described in the present specification may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G (Super 3th generation mobile communication system), IMT-Advanced (International Mobile Telecommunications-Advanced), 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other proper radio communication methods, and/or next-generation systems that are enhanced based on them.

The phrase “based on” as used in this specification does not mean “based only on”, unless otherwise specified. In other words, the phrase “based on” means both “based only on” and “based at least on.”

Any reference to elements with designations such as “first”, “second” and so on as used herein does not generally limit the number/quantity or order of these elements. These designations are used only for convenience, as a method of distinguishing between two or more elements. In this way, reference to the first and second elements does not imply that only two elements may be employed, or that the first element must precede the second element in some way.

The terms “judge” and “determine” as used herein may encompass a wide variety of actions. For example, regarding “judging (determining)”, calculating, computing, processing, deriving, investigating, looking up (for example, looking up a table, a database or some other data structure), ascertaining and so on may be considered as “judging (determining)”. Furthermore, regarding “judging (determining)”, receiving (for example, receiving information), transmitting (for example, transmitting information), inputting, outputting, accessing (for example, accessing data in a memory) and so on may be considered as “judging (determining)”. In addition, regarding “judging (determining)”, resolving, selecting, choosing, establishing, comparing and so on may be considered as “judging (determining)”. In other words, regarding “judging (determining)”, some actions may be considered as “judging (determining)”.

As used herein, the terms “connected” and “coupled”, or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of them. For example, “connection” may be replaced as “access.” As used herein, two elements may be considered “connected” or “coupled” to each other by using one or more electrical wires, cables and/or printed electrical connections, and, as a number of non-limiting and non-inclusive examples, by using electromagnetic energy having wavelengths in radio frequency fields, microwave regions and/or optical (both visible and invisible) regions.

When terms such as “include”, “comprise” and variations of them are used in this specification or in claims, these terms are intended to be inclusive, in a manner similar to the way the term “provide” is used. Furthermore, the term “or” as used in this specification or in claims is intended to be not an exclusive disjunction.

Although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1-25. (canceled)

26. A base station, comprising:
an allocating unit, configured to allocate, to the first type of UE, a plurality of candidate resources for a sidelink transmission, where the first type of UE carries out a sidelink transmission by base station scheduling;
a transmitting unit, configured to transmit scheduling information about the plurality of candidate resources to the first type of UE.

27. A user equipment, the user equipment is a first type of UE, and the first type of UE carries out a sidelink transmission by base station, comprising:
a receiving unit, configured to receive a first resource allocated by a base station for the sidelink transmission;
a determining unit, configured to determine whether the first resource collides with a second resource used by a second type of UE for the sidelink transmission, where the second type of UE autonomously carries out the sidelink transmission;
a selecting unit, configured to automatically select a third resource different from the second resource to carry out the sidelink transmission when the first resource collides with the second resource.

28. The user equipment of claim 27, wherein the selecting unit
stops using the third resource for carrying out the sidelink transmission when transmission of one data block is completed by using the third resource;
stops using the third resource for carrying out the sidelink transmission when a reselection of a semi-permanent scheduling is triggered;
stops using the third resource for carrying out the sidelink transmission when a preset time or period lapses; and/or
stops using the third resource for carrying out the sidelink transmission when the UE receives a new scheduling resource from the base station.

29. The user equipment of claim 27, wherein
the third resource is selected from a second resource pool, and the second resource pool is associated with a first resource pool, wherein the first resource pool is used for information transmission of the first type of UE in a sidelink transmission mode, and the second resource pool is used for information transmission of the second type of UE in the sidelink transmission mode.

30. The user equipment of claim 29, wherein
an association between the second resource pool and the first resource pool is configured by the base station.

31. The user equipment of claim 27, wherein
the selecting unit carries out an autonomous selection of the third resource and the sidelink transmission by using parameters of the semi-persistent scheduling configured by the base station.

32. The user equipment of claim 27, wherein
the selecting unit transmits the third resource autonomously selected by the first type of UE for the sidelink transmission to the base station.

33. The user equipment of claim 27, wherein
the selecting unit transmits a scheduling abandonment report to the base station, the scheduling abandonment report indicates that the first type of UE abandons the first resource scheduled by the base station.

34. The user equipment of claim 26, wherein the allocating unit
receives feedback information about a selection of the plurality of candidate resources by the first type of UE;
determines resources of the first type of UE for carrying out the sidelink transmission from the plurality of candidate resources, according to the feedback information of the first type of UE, so that the first type of UE carries out the sidelink transmission with the determined resources.

35. The user equipment of claim 26, wherein the transmitting unit
transmits the scheduling information about the plurality of candidate resources through a plurality of pieces of downlink control information.

36. The user equipment of claim 35, wherein
a delay between any one piece of the downlink control information used to indicate the candidate resources and any one of the candidate resources is greater than a minimum required value.

37. The user equipment of claim 36, wherein
a delay between the candidate resource and the downlink control information indicating the candidate resource may be statically configured or dynamically adjusted with delay indication information in the downlink control information.

38. The user equipment of claim 35, wherein
the plurality of pieces of downlink control information are respectively in a plurality of consecutive time slots.

39. The user equipment of claim 26, wherein the transmitting unit
transmits the scheduling information about the plurality of candidate resources through one piece of downlink control information.

40. The user equipment of claim 26, wherein the transmitting unittransmits the scheduling information about the plurality of candidate resources through higher layer information.

41. A user equipment, the user equipment being a first type of UE, and the first type of UE carries out a sidelink transmission by base station scheduling, comprising:
a receiving unit, configured to receive a plurality of resources allocated by a base station for the sidelink transmission;
a transmission unit, configured to carry out the sidelink transmission with one of the plurality of candidate resources.

42. The user equipment of claim 41, wherein the transmission unit
transmits feedback information about a selection of the plurality of candidate resources, so that the base station determines resources of the first type of UE for carrying out the sidelink transmission from the plurality of candidate resources according to the feedback information,
carries out the sidelink transmission with the determined resources.

43. The user equipment of claim 42, wherein the transmission unit
determines selected and/or unselected candidate resources;
feeds back at a feedback information position corresponding to downlink control information indicating the selected and/or unselected candidate resources.

44. The user equipment of claim 41, wherein the transmission unit
selects resources for carrying out the sidelink transmission from the plurality of candidate resources;
carries out the sidelink transmission with the selected resources.
